(19) United States
(12) Patent Application Publication
(10) Pub. No.: US 2023/0161276 A1
(43) Pub. Date: May 25, 2023

(54) TONER, TONER PRODUCTION METHOD, TONER STORAGE UNIT, AND IMAGE FORMING APPARATUS

(71) Applicants: Mitsuaki HIROSE, Shizuoka (JP); Daisuke INOUE, Shizuoka (JP); Yohichi KITAGAWA, Shizuoka (JP); Tsukiko TAKAHASHI, Shizuoka (JP); Kenji KOMITO, Tokyo (JP); Akihiko MOKI, Kanagawa (JP)

(72) Inventors: Mitsuaki HIROSE, Shizuoka (JP); Daisuke INOUE, Shizuoka (JP); Yohichi KITAGAWA, Shizuoka (JP); Tsukiko TAKAHASHI, Shizuoka (JP); Kenji KOMITO, Tokyo (JP); Akihiko MOKI, Kanagawa (JP)

(21) Appl. No.: 17/991,846

(22) Filed: Nov. 22, 2022

(30) Foreign Application Priority Data
Nov. 24, 2021 (JP) 2021-190219
Oct. 6, 2022 (JP) 2022-161918

(51) Int. Cl. G03G 9/08; G03G 9/087

(52) U.S. Cl. CPC G03G 9/0821; G03G 9/0804; G03G 9/0827; G03G 9/08728

(57) ABSTRACT

Provided is a toner including toner particles. Each of the toner particles includes a toner base particle including a binder resin and a release agent. The toner particles have an average circularity of 0.974 or greater and 0.985 or less. An arithmetic mean height Sa of surfaces of the toner particles is 45 nm or greater. The toner particles have a BET specific surface area of 1.3 m²/g or greater and 2.5 m²/g or less.

### CROSS-REFERENCE TO RELATED APPLICATION

The present application claims priority under 35 U.S.C. § 119 to Japanese Patent Application No. 2021-190219, filed Nov. 24, 2021, and Japanese Patent Application No. 2022-161918, filed Oct. 6, 2022, the contents of which are incorporated herein by reference in their entirety.

### BACKGROUND OF THE INVENTION

### 1. Field of the Invention

The disclosures herein generally relate to a toner, a toner production method, a toner storage unit, and an image forming apparatus.

### 2. Description of the Related Art

In the field of electrophotographic image formation, a color image forming apparatus capable of forming high quality images with high speed has been desired in recent years.

Meanwhile, the following toner has been proposed for improving cleaning properties of a toner. Proposed is a toner where shapes of toner particles are controlled to have irregular shapes, not spherical shapes, to prevent the toner particles from slipping through a cleaning blade (see, for example, Japanese Unexamined Patent Application Publication No. 2005-037892).

Moreover, the following toner has been proposed. An arithmetic mean height of surfaces of toner base particles is adjusted to prevent uneven distribution of an external additive on the toner base particles to improve a transfer rate of the toner (see, for example, Japanese Unexamined Patent Application Publication No. 2005-258031).

### SUMMARY OF THE INVENTION

In one embodiment, a toner includes toner particles. Each of the toner particles includes a toner base particle. The toner particles have an average circularity of 0.974 or greater and 0.985 or less. An arithmetic mean height Sa of surfaces of the toner particles is 45 nm or greater. The toner particles have a BET specific surface area of 1.3 m²/g or greater and 2.5 m²/g or less.

### BRIEF DESCRIPTION OF THE DRAWINGS

FIG. 1 is a schematic view illustrating an example of an image forming apparatus using the toner of the present disclosure;

FIG. 2 is a schematic view illustrating another example of the image forming apparatus using the toner of the present disclosure;

FIG. 3 is a schematic view illustrating yet another example of the image forming apparatus using the toner of the present disclosure;

FIG. 4 is an enlarged partial view of FIG. 3; and

FIG. 5 is a schematic view illustrating an example of a process cartridge.

### DESCRIPTION OF THE PREFERRED EMBODIMENTS

In the following, embodiments of the present invention will be described with reference to the accompanying drawings.

Further, the present invention is not limited to these embodiments, but various variations and modifications may be made without departing from the scope of the present invention.

### (Toner)

The toner of the present disclosure includes toner particles. Each of the toner particles includes a toner base particle. The toner base particle includes at least a binder resin and a release agent. The toner particles have an average circularity of 0.974 or greater and 0.985 or less. An arithmetic mean height Sa of surfaces of the toner particles is 45 nm or greater. The toner particles have a BET specific surface area of 1.3 m²/g or greater and 2.5 m²/g or less.

In the present specification, the term “toner” means a group of toner particles, the term “toner particle” means a toner base particle on which particles of an external additive and/or other additives etc. are deposited, and the term “toner base particle” means a particle that is a base of the toner particle and includes at least a binder resin and a release agent.

The toner proposed in the art (Japanese Unexamined Patent Application Publication No. 2005-037892) has the following problem. Since the irregular-shaped toner particles increase a contact area with an image bearer compared to spherical toner particles, adhesion force between the image bearer and the toner particles increases. Therefore, a transfer rate of the toner decreases because the toner particles adhered to the image bearer are not easily transferred.

Moreover, the toner proposed in the art (Japanese Unexamined Patent Application Publication No. 2005-258031) has the following problem. Particles of the external additive are trapped in fine recesses formed at a surface of each toner base particle, thus an effect of the external additive may not be adequately exhibited. As a result, the toner particles may slip through a cleaning member, leading to impaired cleaning properties.

To solve the above-described problems in the art, the present inventors have diligently conducted research. As a result, the present inventors have found that, when toner base particles have an average circularity of 0.974 or greater and 0.985 or less, the following advantages are acquired. Specifically, a contact area between the toner and a transfer member or an electrostatic latent image bearer reduces. The reduced contact area assures excellent transfer properties of the toner. Friction is caused between a cleaning blade and the toner particles; thus, the toner particles do not easily roll on the electrostatic latent image bearer or the transfer member. Therefore, the toner particles are prevented from slipping through the cleaning blade, consequently assuring excellent cleaning properties.

Moreover, the present inventors have found that, when the arithmetic mean height Sa of surfaces of the toner base particles is 45 nm or greater, the following advantages are assured. Specifically, as a difference in height in a surface profile of the toner base particle is large, friction is caused between a cleaning blade and the toner particles to prevent the toner particles from easily rolling on the electrostatic latent image bearer or the transfer member. Therefore, the toner particles are prevented from slipping through the cleaning blade, consequently assuring excellent cleaning properties.

Moreover, the present inventors have found that, when the toner base particles have a BET specific surface area of 1.3 m²/g or greater and 2.5 m²/g or less, a covering rate of toner particles with the external additive is low, which assures excellent fixability and excellent cleaning properties of a resulting toner.

The present disclosure has an object to provide a toner that can assure both excellent cleaning properties and excellent transfer properties.

The present disclosure can provide a toner that can assure both excellent cleaning properties and excellent transfer properties.

### <Average Circularity>

The average circularity of the toner particles is 0.974 or greater and 0.985 or less, and preferably 0.974 or greater and 0.982 or less. When the average circularity of the toner particles is 0.974 or greater, a contact area between the toner and a transfer member or electrostatic latent image bearer reduces, consequently assuring excellent transfer properties of the toner. When the average circularity of the toner base particles is 0.985 or less, the toner particles do not easily roll on an electrostatic latent image bearer or transfer member as friction is caused between a cleaning blade and the toner, consequently, preventing the toner particles from slipping through the cleaning blade, and assuring excellent cleaning properties.

A method of measuring the average circularity of the toner base particles is not particularly limited, and may be appropriately selected in accordance with the intended purpose. For example, the average circularity of the toner base particles can be measured by means of a flow particle image analyzer and analysis software.

Examples of the flow particle image analyzer include a wet flow particle image analyzer (FPIA-2100).

Examples of the analysis software include FPIA-2100 Data Processing Program for FPIA version 00-10 (available from SYSMEX CORPORATION).

Specifically, the average circularity of the toner base particles is measured in the following manner. A 100 mL glass beaker is charged with 0.1 mL through 0.5 mL of a 10% alkylbenzene sulfonic acid salt (NEOGEN SC-A, available from DKS Co., Ltd.) aqueous solution and from 0.1 g through 0.5 g of the toner. The resulting mixture is stirred by means of a microspartel, followed by adding 80 mL of ion-exchanged water.

Next, the resulting mixture is dispersed by means of an ultrasonic disperser UH-50 (available from SMT CO., LTD.) for 1 minute at 20 kHz, and at 50 W/10 cm³. After dispersing for 5 minutes in total, a measurement sample is obtained.

The measurement sample having a particle concentration of from 4,000 particles/10⁻³ cm³ through 8,000 particles/10⁻³ cm³ is used to measure the average circularity of the particles each having a circle equivalent diameter of 0.60 μm or greater and less than 159.21 μm. Based on the measured average circularity, the average circularity of the toner particles is calculated.

### <Arithmetic Mean Height Sa>

The arithmetic mean height Sa is 45 nm or greater, and preferably 50 nm or greater and 105 nm or less. When the arithmetic mean height Sa is 45 nm or greater, a difference in height of a surface profile of each of the toner base particles is large, and the large difference in the height causes friction between a cleaning blade and the toner to prevent the toner particles from rolling, consequently, preventing the toner particles from slipping through a cleaning blade and assuring excellent cleaning properties.

The arithmetic mean height Sa can be measured by a scanning probe microscope (SPM) method. The SPM method is a method where a sample surface (e.g., a surface of a toner particle) is scanned with a probe with a tip having a diameter of about 10 nm to detect the atomic force acting between the probe and the atoms present at the surface of the sample to measure a surface profile of the sample.

The SPM method has extremely high resolution, and can measure a profile (i.e., the z-axial direction) relative to the scanning direction (i.e., the x-axial direction) of the probe. When a surface profile of the toner particle is measured by the SPM method, an area, which is about 1 μm², located near a peak of a certain toner particle is scanned with a tip of a probe. During the scanning, the vertical deviation along the z-axial direction is determined as a surface profile (i.e., the arithmetic mean height Sa) of the toner base particle. The measurement of the arithmetic mean height Sa is performed from 3 times through 10 times with changing measuring points within one toner particle, or changing toner particles to be measured, to capture a shape of a whole particle and shapes of all particles. After evaluating the surface profile from the observation image to confirm the deposition state of the additive, a quantitative surface profile analysis is performed.

Specific conditions of the SPM measuring device are as follows.

Measuring device: Atomic force microscope system,
Dimension Icon, available from Bruker AXS

### Measuring Mode

Peak Force QNM

OMCL-AC240TS

Material: Si

Resonance frequency: 70 [Hz]

Cantilever spring constant: 2 [N/m]

### <BET Specific Surface Area>

The BET specific surface area is 1.3 m²/g or greater and 2.5 m²/g or less, and preferably 1.4 m²/g or greater and 2.1 m²/g or less. When the BET specific surface area is 1.3 m²/g or greater, the coverage rate of the toner base particles with the external additive is low, consequently assuring excellent fixability. When the BET specific surface area is 2.5 m²/g or less, particles of the external additive are prevented from being embedded in the toner base particle, consequently assuring excellent cleaning properties.

A measuring method of the BET specific surface area is not particularly limited, and may be appropriately selected in accordance with the intended purpose. For example, the BET specific surface area can be measured by means of an automatic surface area and porosity analyzer (TriStar3000, available from Shimadzu Corporation).

Specifically, the toner is weighed by about 0.5 g and collected in a sample cell. The collected sample is vacuum-dried for 24 hours by means of Pretreatment Smart-Prep (available from Shimadzu Corporation) to remove impurities and moisture on the surface of the sample. After the pretreatment, the sample is set in the automatic surface area and porosity analyzer (TriStar3000, available from Shimadzu Corporation) to determine relation between the nitrogen gas adsorption and relative pressure. The BET specific surface area of the toner particles was determined from the relation between the nitrogen gas adsorption and the relative pressure according to the multipoint BET method.

A method of adjusting the average circularity, the arithmetic mean height Sa, or the BET specific surface area is not particularly limited, and may be appropriately selected in accordance with the intended purpose. For example, the average circularity, the arithmetic mean height Sa, or the BET specific surface area can be adjusted by varying an amount of an inorganic filler included in the toner, a heating temperature of a surface treatment in the toner production method, or shearing force during emulsification and/or removal of a solvent in the toner production method.

Specifically, the amount of the inorganic filler is adjusted and the inorganic filler is unevenly distributed at a surface of each of toner base particles so that surface profiles (especially, the average circularity and arithmetic mean height S) of the toner base particles are controlled. The detail of the inorganic filler for use in the present disclosure will be described later.

Since the inorganic filler has high hydrophilicity, the inorganic filler moves towards a surface of each oil droplet, which will form each toner base particle, when an oil phase is dispersed in an aqueous medium to granulate toner base particles during the production of the toner. Since the inorganic filler is present near a surface of each toner base particle, a surface of each toner base particle is deformed to form protrusions on the surface of each toner base particle.

Shapes of the toner base particles may be also adjusted by changing shearing force during emulsification and/or removal of a solvent in the toner production method. According to the toner production method of the present disclosure, an oil phase including a binder resin, an inorganic filler, a release agent, a colorant, etc., is emulsified and dispersed in an aqueous phase to produce the toner. As shearing force is increased when the oil phase is dispersed, the inorganic filler, which will be arranged at surfaces of toner base particles, is dispersed to be fine fragments so that protrusions are formed on surfaces of the toner base particles, and the average circularity and the arithmetic mean height S are controlled. Especially, the arithmetic mean height S is easily controlled.

Shapes of the toner base particles may be also adjusted by changing a heating temperature of a surface treatment in the toner production method. During the production of the toner base particles for the toner of the present disclosure, a filtration cake, which has been subjected to removal of a solvent and washing, is processed through a heat treatment to level surfaces of the toner base particles to reduce protrusions on surfaces of the toner base particles. As a result, the arithmetic mean height S and the BET specific surface area are reduced. Especially, the BET specific surface area is easily controlled.

The heating temperature is preferably 53° C. or lower.

When the heating temperature is 53° C. or lower, the toner of the present disclosure is easily produced.

In the present disclosure, the average circularity, the arithmetic mean height Sa, and the BET specific surface area are preferably controlled by combining adjustment with the inorganic filler, adjustment with mixing conditions during emulsification and dispersion during the production, and adjustment of the heat treatment of the surface treatment.

The toner includes toner particles. Each of the toner particles includes a toner base particle, and preferably further includes external additives. The toner particles may further include other components according to the necessity. Each of the toner base particles includes at least a binder resin and a release agent.

### <Toner Base Particles>

Each of the toner base particles includes at least a binder resin and a release agent, and preferably further includes a colorant, and an inorganic filler. Each of the toner base particles may further include other components according to the necessity.

### <<Binder Resin>>

The binder resin preferably includes a crystalline resin, and an amorphous resin (may be also referred to as a “non-crystalline resin” hereinafter).

### —Crystalline Resin—

The crystalline resin is not particularly limited, and may be appropriately selected in accordance with the intended purpose. Examples of the crystalline resin include an acrylic resin, a styrene-acrylic resin, a polyester resin, and an epoxy resin. Among the above-listed examples, a polyester resin (may be referred to as a crystalline polyester resin hereinafter) is preferable.

The crystalline polyester resin has high crystallinity, as well as heat fusion characteristics such that viscosity of the crystalline polyester resin sharply decreases at a temperature closely to a fixing onset temperature. Therefore, the crystalline polyester resin does not melt and has excellent heat resistant storage stability, when a temperature of the crystalline polyester resin is up to just below the melt onset temperature. When the temperature of the crystalline polyester resin reaches the melt onset temperature, the crystalline polyester resin melts to drastically decrease the viscosity to be compatible with an amorphous resin. As a result, the toner is fixed. Therefore, the resulting toner has excellent heat resistant storage stability and excellent low-temperature fixability.

Moreover, the toner having a large difference (i.e., a large release range) between the minimum fixing temperature and the hot-offset onset temperature is obtained.

The crystalline polyester resin is not particularly limited, and may be appropriately selected in accordance with the intended purpose. Examples of the crystalline polyester resin include a polycondensation polyester resin synthesized from a multivalent alcohol and a multivalent carboxylic acid.

The multivalent alcohol is not particularly limited, and may be appropriately selected in accordance with the intended purpose. Examples of the multivalent alcohol include a diol and a trivalent or higher alcohol. The above-listed examples may be used alone or in combination.

The diol is not particularly limited, and may be appropriately selected in accordance with the intended purpose. Examples of the diol include a saturated aliphatic diol.

Examples of the saturated aliphatic diol includes a straight-chain saturated aliphatic diol and a branched-chain saturated aliphatic diol. Among the above-listed examples, a straight-chain saturated aliphatic diol is preferable because a resulting crystalline polyester has high crystallinity. Moreover, a C2-C12 straight-chain saturated aliphatic diol is preferable because a C2-C12 straight-chain saturated aliphatic diol is readily available.

Examples of the saturated aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. Among the above-listed examples, ethylene glycol, 1,4-butanediol, 1,6-hexanediol, 1,8-octanediol, 1,10-decanediol, and 1,12-dodecanediol are preferable because resulting crystalline polyester has high crystallinity and excellent sharp melting properties.

Examples of the trivalent or higher alcohol include glycerin, trimethylolethane, trimethylolpropane, and pentaerythritol.

The multivalent carboxylic acid is not particularly limited, and may be appropriately selected in accordance with the intended purpose. Examples of the multivalent carboxylic acid include a divalent carboxylic acid, and a trivalent or higher carboxylic acid.

The multivalent carboxylic acid may include a sulfonic acid group-containing dicarboxylic acid or a dicarboxylic acid having a carbon double bond (e.g., C═C).

Examples of the divalent carboxylic acid include: a saturated aliphatic dicarboxylic acid, such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; and an aromatic dicarboxylic acid (e.g., diprotic acid), such as phthalic acid, isophthalic acid, terephthalic acid, naphthalene-2,6-dicarboxylic acid, malonic acid, and mesaconic acid.

Examples of the trivalent or higher carboxylic acid include 1,2,4-benzenetricarboxylic acid, 1,2,5-benzenetricarboxylic acid, and 1,2,4-naphthalenetricarboxylic acid.

The crystalline polyester resin preferably includes a constituent unit derived from a C4-C12 straight-chain saturated aliphatic dicarboxylic acid and a constituent unit derived from a C2-C12 straight-chain saturated aliphatic diol. The crystalline polyester resin including the above-mentioned constituent units has high crystallinity, and excellent sharp melting properties, thus use of the crystalline polyester resin can improve low-temperature fixability of a resulting toner.

A melting point of the crystalline polyester resin is not particularly limited, and may be appropriately selected in accordance with the intended purpose. The melting point of the crystalline polyester resin is preferably 60° C. or higher and 90° C. or lower, and more preferably 60° C. or higher and 80° C. or lower. When the melting point of the crystalline polyester resin is 60° C. or higher, heat resistant storage stability of a resulting toner improves. When the melting point of the crystalline polyester resin is 90° C. or lower, low-temperature fixability of a resulting toner improves.

The weight average molecular weight of the crystalline polyester resin is preferably from 3,000 through 30,000, and more preferably from 5,000 through 15,000. When the weight average molecular weight of the crystalline polyester resin is 3,000 or greater, heat resistant storage stability of a resulting toner improves. When the weight average molecular weight of the crystalline polyester resin is 30,000 or less, low-temperature fixability of a resulting toner improves.

An acid value of the crystalline polyester resin is preferably 5 mgKOH/g or greater and 45 mgKOH/g or less, and more preferably 10 mgKOH/g or greater and 45 mgKOH/g or less. When the acid value of the crystalline polyester resin is 5 mgKOH/g or greater, low-temperature fixability of a resulting toner improves. When the acid value of the crystalline polyester resin is 45 mgKOH/g or less, hot offset resistance of a resulting toner improves.

A hydroxyl value of the crystalline polyester resin is preferably 50 mgKOH/g or less, and more preferably 5 mgKOH/g or greater and 50 mgKOH/g or less. When the hydroxyl value of the crystalline polyester resin is 50 mgKOH/g or less, low-temperature fixability and charging properties of a resulting toner improve.

A molecular structure of the crystalline polyester resin can be confirmed by solution or solid NMR spectroscopy, X-ray diffraction spectroscopy, GC/MS, LC/MS, or IR spectroscopy.

As a simple method of confirming the structure of the crystalline polyester resin, a compound having an absorption, which is based on δCH (out of plane bending) of an olefin, at 965±10 cm⁻¹ or 990±10 cm⁻¹ on an infrared absorption spectrum is detected as the crystalline polyester resin.

### —Amorphous Resin—

The amorphous resin (may be referred to as a “non-crystalline resin” hereinafter) is not particularly limited, and may be appropriately selected in accordance with the intended purpose. Examples of the amorphous resin include an acrylic resin, a styrene-acrylic resin, a polyester resin, and an epoxy resin. The above-listed examples may be used alone or in combination. Among the above-listed examples, a polyester resin (may be referred to as an “amorphous polyester resin,” a “non-crystalline polyester resin,” or “amorphous polyester” hereinafter) is preferable.

The amorphous polyester resin is not particularly limited, and may be appropriately selected in accordance with the intended purpose. Examples of the amorphous polyester resin include a polycondensation polyester resin synthesized from a multivalent alcohol and a multivalent carboxylic acid.

Examples of the multivalent alcohol include a divalent alcohol (i.e., a diol) and a trivalent to octavalent or higher polyol.

The divalent alcohol (i.e., diol) is not particularly limited, and may be appropriately selected in accordance with the intended purpose. Examples of the divalent alcohol include a divalent aliphatic alcohol, such as a straight-chain aliphatic alcohol, and a branched-chain aliphatic alcohol. The above-listed examples may be used alone or in combination. Among the above-listed examples, a C2-C36 aliphatic alcohol is preferable, and a C2-C36 straight-chain aliphatic alcohol is more preferable.

The straight-chain aliphatic alcohol is not particularly limited, and may be appropriately selected in accordance with the intended purpose. Examples of the straight-chain aliphatic alcohol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol.

Among the above-listed examples, ethylene glycol, 1,3-propanediol (propylene glycol), 1,4-butanediol, 1,6-hexanediol, 1,9-nonanediol, 1,10-decanediol are preferable because of material availability.

The multivalent carboxylic acid is not particularly limited, and may be appropriately selected in accordance with the intended purpose. Examples of the multivalent carboxylic acid include a dicarboxylic acid and a trivalent to hexavalent or higher polycarboxylic acid. Among the above-listed examples, a multivalent aromatic carboxylic acid is preferable.

The dicarboxylic acid is not particularly limited, and may be appropriately selected in accordance with the intended purpose. Examples of the dicarboxylic acid include an aliphatic dicarboxylic acid and an aromatic dicarboxylic acid.

Examples of the aliphatic dicarboxylic acid include a straight-chain aliphatic dicarboxylic acid, and a branched-chain aliphatic dicarboxylic acid. Among the above-listed examples, a straight-chain aliphatic dicarboxylic acid is preferable.

The aliphatic dicarboxylic acid is not particularly limited, and may be appropriately selected in accordance with the intended purpose. Examples of the aliphatic dicarboxylic acid include an alkane dicarboxylic acid, an alkenyl succinic acid, an alkene dicarboxylic acid, and an alicyclic dicarboxylic acid.

Examples of the alkane dicarboxylic acid include a C4-C36 alkane dicarboxylic acid.

Examples of the C4-C36 alkane dicarboxylic acid include succinic acid, adipic acid, sebacic acid, azelaic acid, dodecanedioic acid, octadecanedioic acid, and decylsuccinic acid.

Examples of the alkenyl succinic acid include dodecenyl succinic acid, pentadecenyl succinic acid, and octadecenyl succinic acid.

Examples of the alkene dicarboxylic acid include a C4-C36 alkene dicarboxylic acid.

Examples of the C4-C36 alkene dicarboxylic acid include maleic acid, fumaric acid, and citraconic acid.

Examples of the alicyclic dicarboxylic acid include a C6-C40 alicyclic dicarboxylic acid.

Examples of the C6-C40 alicyclic dicarboxylic acid include a dimer acid (e.g., dimerized linoleic acid).

The aromatic dicarboxylic acid is not particularly limited, and may be appropriately selected in accordance with the intended purpose. Examples of the aromatic dicarboxylic acid include a C8-C36 aromatic dicarboxylic acid.

Examples of the C8-C36 aromatic dicarboxylic acid include phthalic acid, isophthalic acid, terephthalic acid, t-butylisophthalic acid, 2,6-naphthalenedicarboxylic acid, and 4,4′-biphenyldicarboxylic acid.

Examples of the trivalent to hexavalent or higher polycarboxylic acid include a C9-C20 aromatic polycarboxylic acid.

Examples of the C9-C20 aromatic polycarboxylic acid include trimellitic acid and pyromellitic acid.

As the dicarboxylic acid, or the trivalent to hexavalent or higher multivalent carboxylic acid, an acid anhydride or C1-C4 alkyl ester of any of the above-listed carboxylic acids may be used.

Examples of the C1-C4 alkyl ester include a methyl ester, an ethyl ester, and an isopropyl ester.

### <<Release Agent>>

The release agent is not particularly limited, and may be appropriately selected in accordance with the intended purpose. Examples of the release agent include vegetable wax (e.g., carnauba wax, cotton wax, Japanese wax, and rice wax), animal wax (e.g., bees wax, and lanolin wax), mineral wax (e.g., ozocerite, and ceresin), petroleum wax (e.g., paraffin wax, microcrystalline wax, and petrolatum wax), hydrocarbon wax (e.g., Fischer-Tropsch wax, polyethylene wax, and polypropylene wax), synthetic wax (e.g., ester, ketone, and ether), and fatty acid amide-based compounds (e.g., 12-hydroxystearic acid amide, stearic acid amide, and phthalimide). Among the above-listed examples, hydrocarbon wax (e.g., paraffin wax, microcrystalline wax, Fischer-Tropsch wax, polyethylene wax, and polypropylene wax) is preferable.

A melting point of the release agent is not particularly limited, and may be appropriately selected in accordance with the intended purpose. The melting point of the release agent is preferably 60° C. or higher and 80° C. or lower. When the meting point of the release agent is 60° C. or higher, heat resistant storage stability of a resulting toner improves. When the melting point of the release agent is 80° C. or lower, hot offset resistance of a resulting toner improves.

An amount of the release agent is not particularly limited, and may be appropriately selected in accordance with the intended purpose. For example, the amount of the release agent is preferably 2% by mass or greater and 10% by mass or less, and more preferably 3% by mass or greater and 8% by mass or less. When the amount of the release agent in the toner is 2% by mass or greater, hot offset resistance and low-temperature fixability of a resulting toner improve. When the amount of the release agent is 10% by mass or less, heat resistant storage stability of a resulting toner improves, and image fogging can be prevented during image formation with the toner.

### <External Additive>

The external additive is not particularly limited, and may be appropriately selected in accordance with the intended purpose. Examples of the external additive include: oxide particles, such as silica particles, titania particles, alumina particles, titanium oxide particles, tin oxide particles, and antimony oxide particles; fatty acid metal salt particles, such as zinc stearate particles, and aluminium stearate particles; and fluoropolymer particles. Among the above-listed examples, silica particles, titania particles, titanium oxide particles, and alumina particles are preferable. The above-listed examples may be used alone or in combination.

The silica is preferably hydrophobic silica obtained by processing the silica with a hydrophobic treatment.

A method of processing the oxide particles to impart hydrophobicity is not particularly limited, and may be appropriately selected in accordance with the intended purpose. Examples of the method include: a method where the oxide particles are treated with a silane coupling agent; and a method where the oxide particles are treated with silicone oil.

The silane coupling agent is not particularly limited, and may be appropriately selected in accordance with the intended purpose. Examples of the silane coupling agent include hexamethyldisilazane, methyltrimethoxysilane, methyltriethoxysilane, and octyltrimethoxysilane.

The silicone oil is not particularly limited, and may be appropriately selected in accordance with the intended purpose. Examples of the silicone oil include dimethyl silicone oil, methyl phenyl silicone oil, chlorophenyl silicone oil, methylhydrogen silicone oil, alkyl-modified silicone oil, fluorine-modified silicone oil, polyether-modified silicone oil, alcohol-modified silicone oil, amino-modified silicone oil, epoxy-modified silicone oil, epoxy/polyether-modified silicone oil, phenol-modified silicone oil, carboxyl-modified silicone oil, mercapto-modified silicone oil, methacryl-modified silicone oil, and α-methylstyrene-modified silicone oil.

Examples of a method of the hydrophobic treatment include a dry surface treatment method where a hydrophobic treating agent is sprayed onto oxide particles, or mixing a vaporized hydrophobic treating agent with oxide particles, followed by heating. During the dry surface treatment method, water, amine, other catalysts, etc. may be mixed. The dry surface treatment method is preferably performed in an inert gas (e.g., nitrogen) atmosphere.

Alternatively, the hydrophobic oxide particles may be obtained by dissolving a hydrophobic treating agent in a solvent, and mixing and dispersing oxide particles in the solution, optionally followed by performing a heat treatment and a drying treatment. The hydrophobic treating agent may be added after or during the mixing and dispersing the oxide particles (e.g., silica particles) in the solvent.

A number average primary particle diameter d of the external additive is not particularly limited, and may be appropriately selected in accordance with the intended purpose. The number average primary particle diameter d is an arithmetic mean primary particle diameter of the external additive based on the number of primary particles of the external additive. The number average primary particle diameter d of the external additive is preferably 80 nm or greater, and more preferably 140 nm or greater and 150 nm or less. When the number average primary particle diameter of the external additive is 80 nm or greater, particles of the external additive are not easily embedded in a surface of each toner base particle. Since the particles of the external additive are not embedded in the toner base particles, friction is caused between a cleaning blade and the toner particles to prevent the toner particles from rolling on an electrostatic latent image bearer or a transfer member. Therefore, the toner particles are prevented from slipping through a cleaning blade, consequently assuring excellent cleaning properties.

The number average primary particle diameter d of the external additive may be controlled by increasing an amount of a silica compound that is a raw material of the external additive, adjusting the outer part of a flame to be long during a production process of the external additive, or increasing a temperature of the outer part of the flame during a production process of the external additive.

Moreover, the particle size distribution of the external additive may be controlled by adjusting a concentration of silica relative to a flame during a production process of the external additive.

A measurement method of the number average primary particle diameter d of the external additive is not particularly limited, and may be appropriately selected in accordance with the intended purpose. For example, the number average primary particle diameter d of the external additive can be measured by observing the external additive on a backscattered electron image of the toner particle captured by a scanning electron microscope (SEM) (SU8230, available from Hitachi High-Tech Corporation), and measuring particle diameters of the primary particles of the external additive.

Specifically, a SEM image of a toner particle is captured by a scanning electron microscope (SEM) (SU8230, available from Hitachi High-Tech Corporation) under the following measuring conditions, and the number average primary particle diameter d of the external additive particles is measured by image analysis. A major axis (a length of the longest part) of a primary particle is measured on 100 particles of the external additive, and an average value of the measured values is calculated. The calculated average value is provided as a number average primary particle diameter d.

### [SEM Measuring Conditions]

Acceleration voltage: 3.0 kV
Working distance (WD): 10.0 mm
Observation magnification: 50,000×

A ratio (d/Sa) of the number average primary particle diameter d of the external additive to the arithmetic mean height Sa of a surfaces of each of the toner particles is not particularly limited, and may be appropriately selected in accordance with the intended purpose. The ratio (d/Sa) is preferably 1 or greater and 3 or less, and more preferably 1 or greater and 2.8 or less. When the ratio (d/Sa) is 1 or greater, cleaning properties of a resulting toner improve owing to a spacer effect imparted by the external additive. When the ratio (d/Sa) is 3 or less, detachment of particles of the external additive from the toner base particles, which may be caused by stress applied to the toner inside a developing unit, is minimized.

A production method of the external additive is not particularly limited, and may be appropriately selected in accordance with the intended purpose. When the external additive is silica particles, examples of the production method include a dry method (e.g., flame hydrolysis and flame combustion) and a wet method (e.g., a sol-gel method). Among the above-listed examples, flame combustion is preferable because silica particles having desirable particle diameters and particle size distribution are easily produced.

In accordance with the flame combustion, silica particles are preferably produced using a burner having a multiple-tube structure. By means of a burner in which an annular tube is disposed at an outer periphery of a central tube, a vaporized raw material (i.e., a silica compound), oxygen, and optionally, an inert gas (e.g., nitrogen) are mixed and fed from the central tube, and a fuel for forming an auxiliary flame (e.g., hydrogen and hydrocarbon) and, optionally, an inert gas (e.g., nitrogen) are mixed and fed from the annular tube. By combusting the above-mentioned gases, the silica compound can be converted into silica particles and the silica particles are appropriately fused in the flame.

Moreover, a burner further including a second annular tube and a third annular tube at a periphery of the burner may be used. The fused silica particles are cooled in the dispersed state, followed by collecting the cooled silica particles.

An amount of the external additive is not particularly limited, and may be appropriately selected in accordance with the intended purpose. The amount of the external additive relative to the toner is preferably 0.1% by mass or greater and 5% by mass or less, and more preferably 0.3% by mass or greater and 3% by mass or less.

### <Inorganic Filler>

The inorganic filler is not particularly limited, and may be appropriately selected in accordance with the intended purpose. Examples of the inorganic filler include calcium carbonate, kaolin clay, talc, barium sulfate, and a layered inorganic mineral. The above-listed examples may be used alone or in combination.

The inorganic filler may be processed by a surface treatment using a silane coupling agent, a surfactant, or metal soap. The inorganic filler may be classified into particles of the inorganic filler having a desired particle size distribution.

The layered inorganic mineral is an inorganic mineral in which layers each having a nanoscale thickness are laminated.

The layered inorganic mineral is not particularly limited, and may be appropriately selected in accordance with the intended purpose. Examples of the layered inorganic mineral include smectite (e.g., montmorillonite, and saponite), kaolin (e.g., kaolinite), magadiite, kanemite, bentonite, hectorte, attapulgite, and sepiolite. Among the above-listed examples, montmorillonite or bentonite, which includes an Al element, is preferable, because an Al element contributes to improvement of charging capability of a resulting toner.

The layered inorganic mineral is preferably a layered inorganic mineral modified with organic ions using an organic ion modifying agent (may be referred to as a “modified layered inorganic mineral” hereinafter). The modification with organic ions is performed by introducing organic ions to ions present between layers of the layered inorganic mineral.

The modified layered inorganic mineral has high hydrophilicity owing to the modified layer structure. When an unmodified layered inorganic mineral is used for granulation of toner particles by adding to and dispersing in an aqueous medium, the unmodified layered inorganic mineral moves into the aqueous medium, thus shapes of toner base particles cannot be made irregular. As the layered inorganic mineral is modified, the modified layered inorganic mineral has high hydrophilicity. Therefore, the modified layered inorganic mineral is finely dispersed during production of a toner and contributes to formation of irregularly shaped toner base particles. Moreover, the modified layered inorganic mineral is predominantly present at a surface of each toner base particle and is uniformly distributed across the entire surface of each toner base particle, consequently assuring a charge controlling effect and low temperature fixability.

A commercial product of the modified layered inorganic mineral is not particularly limited, and may be appropriately selected in accordance with the intended purpose. Examples of the commercial product of the modified layered inorganic mineral include: quaternium-18 bentonite, such as Bentone 3 (available from ELEMENTIS PLC.), Bentone 38 (available from ELEMENTIS PLC.), Bentone 38V (available from ELEMENTIS PLC.), Tixogel VP (available from United catalyst), Claytone 34 (available from Southern Clay (ECKART)), Claytone 40 (available from Southern Clay (ECKART)), and Claytone XL (available from Southern Clay (ECKART)); stearalkonium bentonite, such as Bentone 27 (available from ELEMENTIS PLC.), Tixogel LG (available from United catalyst), Claytone AF (available from Southern Clay (ECKART)), and Claytone APA (available from Southern Clay (ECKART)); and quaternium-18/benzalkonium bentonite, such as Claytone HT (available from Southern Clay (ECKART)), Claytone PS (available from Southern Clay (ECKART)). Among the above-listed examples, Claytone AF and Claytone APA are preferable.

Moreover, the layered inorganic mineral is preferably DHT-4A (available from Kyowa Chemical Industry Co., Ltd.) that is modified with an organic anion represented by General Formula (3) below.

Examples of the organic anion represented by General Formula (3) include HITENOL 330T (available from DKS Co., Ltd.).

R1(OR2)ₙOSO₃M General Formula (3)

In General Formula (3), R1 is a C13 alkyl group, R2 is a C2-C6 alkylene group, n is an integer of from 2 through 10, and M is a monovalent metal element.

An amount of the layered inorganic mineral is not particularly limited, and may be appropriately selected in accordance with the intended purpose. The amount of the layered inorganic mineral is preferably 0.2% by mass or greater and 1.5% by mass or less.

The modified layered inorganic mineral is preferably an organic cation-modified layered inorganic mineral having a smectite-based crystal structure.

Moreover, part of divalent metal elements of the layered inorganic mineral can be substituted with trivalent metal elements to introduce metal anions.

The metal anion is preferably a metal anion at least part of which is modified with an organic anion. Since at least part of ions present between layers of the layered inorganic mineral is modified with an organic ion, the resulting layered inorganic mineral has appropriate hydrophobicity, and an oil phase including constituent materials of toner base particles and a precursor thereof exhibits non-Newtonian viscosity. Therefore, irregularly-shaped toner base particles can be formed.

The organic ion modifying agent is not particularly limited, and may be appropriately selected in accordance with the intended purpose. Examples of the organic ion modifying agent include a quaternary alkylammonium salt, a phosphonium salt, and imidazolium salt. Among the above-listed examples, a quaternary alkylammonium salt is preferable.

Examples of the quaternary alkylammonium salt include a trimethylstearylammonium salt, a dimethylstearylbenzylammonium salt, a dimethyloctadecylammonium salt, and an oleylbis(2-hydroxyethyl)methylammonium salt.

The organic ion modifying agent is not particularly limited, and may be appropriately selected in accordance with the intended purpose. Examples of the organic ion modifying agent include a sulfuric acid salt, a sulfonic acid salt, a carboxylic acid salt, or phosphoric acid having a branched, non-branched, or cyclic alkyl (C1-C44), alkenyl (C1-C22), alkoxy (C8-C32), hydroxyalkyl (C2-C22), ethylene oxide, or propylene oxide. Among the above-listed examples, a carboxylic acid salt having an ethylene oxide skeleton.

An amount of the inorganic filler is not particularly limited, and may be appropriately selected in accordance with the intended purpose. The amount of the inorganic filler is preferably 6 parts by mass or greater and 12 parts by mass or less, and more preferably 6 parts by mass or greater and 9 parts by mass or less.

When the amount of the inorganic filler is less than 6 parts by mass, deformation of toner base particles may not occur and an average circularity of resulting toner particles becomes high. When the amount of the inorganic filler is greater than 12 parts by mass, deformation of toner base particles I easily occurs and an average circularity of resulting toner particles becomes low. When the amount of the inorganic filler is 6 parts by mass or greater and 12 parts by mass of less, the toner of the present disclosure is easily produced.

### <Other Components>

The above-mentioned other components are not particularly limited, and may be appropriately selected in accordance with the intended purpose. Examples of the above-mentioned other components include a colorant, a charge-controlling agent, a cleaning-improving agent, and a magnetic material.

The colorant is not particularly limited, and may be appropriately selected in accordance with the intended purpose. Examples of the colorant include carbon black, a nigrosine dye, iron black, naphthol yellow S, Hansa yellow (10G, 5G, G), cadmium yellow, yellow iron oxide, yellow ocher, yellow lead, titanium yellow, polyazo yellow, oil yellow, Hansa yellow (GR, A, RN, R), pigment yellow L, benzidine yellow (G, GR), permanent yellow (NCG), Vulcan fast yellow (5G, R), tartrazine lake, quinoline yellow lake, anthrasan yellow BGL, isoindolinon yellow, red iron oxide, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL and F4RH), fast scarlet VD, valcan fast rubin B, brilliant scarlet G, lithol rubin GX, permanent red FSR, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, and lithopone. The above-listed examples may be used alone or in combination.

An amount of the colorant is not particularly limited, and may be appropriately selected in accordance with the intended purpose. The amount of the colorant is preferably 1% by mass or greater and 15% by mass or less, and more preferably 3% by mass or greater and 10% by mass or less.

The pigment may be also used as a master batch in which the pigment forms a composite with a resin.

The resin is not particularly limited, and may be appropriately selected in accordance with the intended purpose. Examples of the resin include: polymers of styrene or substituted styrene [e.g., polystyrene, poly(p-chlorostyrene), and polyvinyl toluene]; styrene-based copolymers, such as a styrene-p-chlorostyrene copolymer, a styrene-propylene copolymer, a styrene-vinyl toluene copolymer, a styrene-vinyl naphthalene copolymer, a styrene-methyl acrylate copolymer, a styrene-ethyl acrylate copolymer, a styrene-butyl acrylate copolymer, a styrene-octyl acrylate copolymer, a styrene-methyl methacrylate copolymer, a styrene-ethyl methacrylate copolymer, a styrene-butyl methacrylate copolymer, a styrene-methyl α-chloromethacrylate copolymer, a styrene-acrylonitrile copolymer, a styrene-methyl vinyl ketone copolymer, a styrene-butadiene copolymer, a styrene-isoprene copolymer, a styrene-acrylonitrile-indene copolymer, a styrene-maleic acid copolymer, and a styrene-maleic acid ester copolymer; polymethyl methacrylate; polybutyl methacrylate; polyvinyl chloride; polyvinyl acetate; polyethylene; polypropylene; polyester; an epoxy resin; an epoxypolyol resin; polyurethane; polyamide; polyvinyl butyral; polyacrylic acid; rosin; modified rosin; a terpene resin; an aliphatic or alicyclic hydrocarbon resin; and an aromatic petroleum resin. The above-listed examples may be used alone or in combination.

The master batch can be obtained by mixing and kneading the resin and the pigment. During the mixing and kneading, an organic solvent may be used to enhance interaction between the pigment and the resin.

As a production method of the master batch, for example, a flashing method is used. The flashing method is a method where an aqueous paste of a pigment, a resin, and an organic solvent are mixed and kneaded together to transfer the pigment to the side of the resin, followed by removing the water and the organic solvent. According to the flashing method, a wet cake of the pigment can be used as it is, thus it is not necessary to dry the pigment.

A device used for the mixing and kneading is not particularly limited, and may be appropriately selected in accordance with the intended purpose. Examples of the device include a high-shearing disperser, such as a three-roll mill.

The cleaning-improving agent is not particularly limited, and may be appropriately selected in accordance with the intended purpose.

Examples of the cleaning-improving agent include: a fatty acid metal salt, such as zinc stearate, and calcium stearate; and polymer particles produced by soap-free emulsion polymerization, such as polymethyl methacrylate particles, and polystyrene particles.

A volume average particle diameter of the polymer particles is not particularly limited, and may be appropriately selected in accordance with the intended purpose. The volume average particle diameter of the polymer particles is preferably 0.01 μm or greater and 1 μm or less.

The magnetic material is not particularly limited, and may be appropriately selected in accordance with the intended purpose. Examples of the magnetic material include iron, magnetite, and ferrite.

The magnetic material is preferably a white material considering a color tone.

### <Toner Production Method>

The toner production method is not particularly limited, provided that the toner production method is a method of producing toner base particles having the shapes specified in the present disclosure. The toner production method may be appropriately selected in accordance with the intended purpose. Examples of the toner production method include a dissolution suspension method.

The toner production method includes dissolving or dispersing a binder resin in an organic solvent to produce an oil phase, and dispersing the oil phase in an aqueous phase to form toner base particles. The toner production method preferably further includes other steps, such as emulsification and removal of a solvent, washing, a surface treatment step, and drying.

The toner is preferably produced by emulsifying or dispersing an oil phase in an aqueous medium, where the oil phase includes an isocyanate group-containing amorphous polyester prepolymer A and amorphous polyester B, and optionally crystalline polyester C, a release agent, and a colorant.

The aqueous medium is preferably an aqueous medium in which resin particles are dispersed.

The aqueous medium is not particularly limited, provided that the aqueous medium is a solvent miscible with water. The aqueous medium may be appropriately selected in accordance with the intended purpose. Examples of the aqueous medium include an organic solvent, and water. The above-listed examples may be used alone or in combination. Among the above-listed examples, water is preferable.

The organic solvent is not particularly limited, and may be appropriately selected in accordance with the intended purpose. Examples of the organic solvent include alcohol, toluene, xylene, benzene, carbon tetrachloride, dichloromethane, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, dimethylformamide, tetrahydrofuran, cellosolves, and lower ketones. The above-listed examples may be used alone or in combination. Among the above-listed examples, ethyl acetate, toluene, xylene, benzene, dichloromethane, 1,2-dichloroethane, chloroform, and carbon tetrachloride are preferable, and ethyl acetate is more preferable.

Examples of the alcohol include methanol, isopropanol, and ethylene glycol.

Examples of the lower ketones include acetone, and methyl ethyl ketone.

A boiling point of the organic solvent is not particularly limited, and may be appropriately selected in accordance with the intended purpose. The boiling point of the organic solvent is preferably lower than 150° C. Since the organic solvent having a boiling point of lower than 150° C. is used, the organic solvent is easily removed.

A resin constituting the resin particles is not particularly limited, provided that the resin can be dispersed in an aqueous medium. The resin may be appropriately selected in accordance with the intended purpose. Examples of the resin include a vinyl-based resin, a polyurethane resin, an epoxy resin, a polyester resin, a polyamide resin, a polyimide resin, a silicon-based resin, a phenol resin, a melamine resin, a urea resin, an aniline resin, an ionomer resin, and a polycarbonate resin. The above-listed examples may be used alone or in combination. Among the above-listed examples, a vinyl-based resin, a polyurethane resin, an epoxy resin, and a polyester resin are preferable because fine spherical resin particles are easily formed.

An amount of the resin particles relative to the aqueous medium is preferably 0.005% by mass or greater and 0.1% by mass or less.

When the oil phase is emulsified or dispersed in the aqueous medium, the isocyanate group-containing amorphous polyester prepolymer A and an active hydrogen group-containing compound are allowed to react to generate an amorphous polyester A.

The amorphous polyester A can be generated according to any of the following methods (1) to (3):

(1) a method where an oil phase including an isocyanate group-containing amorphous polyester prepolymer A and an active hydrogen group-containing compound is emulsified or dispersed in an aqueous medium to allow the active hydrogen group-containing compound and the isocyanate group-containing amorphous polyester prepolymer A to react through an elongation reaction and/or a cross-linking reaction in the aqueous medium to generate an amorphous polyester A;
(2) a method where an oil phase including an isocyanate group-containing amorphous polyester prepolymer A is emulsified or dispersed in an aqueous medium to which an active hydrogen group-containing compound has been added, and the active hydrogen group-containing compound and the isocyanate group-containing amorphous polyester prepolymer A are allowed to react through an elongation reaction and/or a cross-linking reaction in the aqueous medium to generate an amorphous polyester A; and
(3) a method where an oil phase including an isocyanate group-containing amorphous polyester prepolymer A is emulsified or dispersed in an aqueous medium, an active hydrogen group-containing compound is added to the aqueous medium, and the active hydrogen group-containing compound and the isocyanate group-containing amorphous polyester prepolymer A are allowed to react through an elongation reaction and/or a cross-linking reaction at an interface of each of the oil phase particles in the aqueous medium to generate amorphous polyester A.

When the active hydrogen group-containing compound and the isocyanate group-containing amorphous polyester prepolymer A are allowed to react through an elongation reaction and/or a cross-linking reaction at an interface of each oil phase particle in the aqueous medium, an amorphous polyester A is generated predominantly at a surface of each oil phase particle, which will be a toner base particle, to impart a density gradient of the amorphous polyester A within the toner base particle.

Duration of the reaction between the active hydrogen group-containing compound and the isocyanate group-containing amorphous polyester prepolymer A is preferably 10 minutes or longer and 40 hours or shorter, and more preferably 2 hours or longer and 24 hours or shorter.

A temperature of the reaction between the active hydrogen group-containing compound and the isocyanate group-containing amorphous polyester prepolymer A is preferably 0° C. or higher and 150° C. or lower, and more preferably 40° C. or higher and 98° C. or lower.

When the active hydrogen group-containing compound and the isocyanate group-containing amorphous polyester prepolymer A are allowed to react, a catalyst may be used.

The catalyst is not particularly limited, and may be appropriately selected in accordance with the intended purpose. Examples of the catalyst include dibutyl tin laurate, and dioctyl tin laurate.

A method of emulsifying or dispersing the oil phase in the aqueous medium is not particularly limited, and may be appropriately selected in accordance with the intended purpose. Examples of the method include a method where an oil phase is added to an aqueous medium, and the resulting mixture is dispersed with shearing force.

A dispersing device used for emulsifying or dispersing the oil phase in the aqueous medium is not particularly limited, and may be appropriately selected in accordance with the intended purpose. Examples of the dispersing device include a low-speed shearing dispersing device, a high-speed shearing dispersing device, a friction dispersing device, a high-pressure jet dispersing device, and an ultrasonic dispersing device. Among the above-listed examples, a high-speed shearing dispersing device is preferable as particle diameter of dispersed elements (i.e., oil droplets) can be adjusted to the range of from 2 μm to 20 μm.

When the high-speed shearing disperser is used, the rotational speed is preferably 1,000 rpm or greater and 30,000 rpm or less, more preferably 5,000 rpm or greater and 20,000 rpm or less, and particularly preferably 8,000 rpm or greater and 20,000 rpm or less.

Duration of the dispersion is preferably 0.1 minutes or longer and 5 minutes or shorter.

A temperature of the dispersion is preferably 0° C. or higher and 150° C. or lower, and more preferably 40° C. or higher and 98° C. or lower under pressure.

A mass ratio of the aqueous medium to the constituent materials of the toner base particles (may be referred to as a “toner material”) is preferably 0.5 or greater and 20 or less, and more preferably 1 or greater and 10 or less. When the mass ratio is 0.5 or greater, the oil phase is suitably dispersed in the aqueous medium. When the mass ratio is 20 or less, cost effective production can be achieved.

The aqueous medium preferably includes a dispersing agent, an aggregating agent, etc. Since the aqueous medium includes a dispersing agent, dispersion stability of oil droplets improves when the oil phase is emulsified or dispersed in the aqueous medium. Therefore, resulting toner base particles can be formed into desired shapes with a narrow particle size distribution. Since the aqueous medium includes an aggregating agent, each of resulting toner base particles has a particle shape where large and wide recesses are formed at a surface of each of the toner base particles.

The dispersing agent is not particularly limited, and may be appropriately selected in accordance with the intended purpose. Examples of the dispersing agent include a surfactant, a poorly water-soluble inorganic compound dispersing agent, and a polymer-based protective colloid. The above-listed examples may be used alone or in combination. Among the above-listed examples, a surfactant is preferable.

Examples of the surfactant include an anionic surfactant, a cationic surfactant, a nonionic surfactant, and an amphoteric surfactant. Among the above-listed examples, a fluoroalkyl group-containing surfactant is preferable.

Examples of the anionic surfactant include an alkyl benzene sulfonic acid salt, an α-olefin sulfonic acid salt, and a phosphoric acid ester.

The aggregating agent is not particularly limited, and may be appropriately selected in accordance with the intended purpose. Examples of the aggregating agent include an inorganic metal salt, and a divalent or higher metal complex.

Examples of the inorganic metal salt include a sodium salt, a magnesium salt, an aluminium salt, and polymers of the foregoing inorganic metal salts. Among the above-listed examples, a sodium salt is preferable because the sodium salt facilitates control of particle diameters and shapes of resulting toner base particles.

An amount of the aggregating agent is not particularly limited, and may be appropriately selected in accordance with the intended purpose. An amount of the aggregating agent in the aqueous medium (i.e., the aggregating agent solid content of the aqueous medium) is preferably 1.2% by mass or greater and 5.0% by mass or less, and 1.2% by mass or greater and 3.0% by mass or less.

In the toner production method, a surface treatment is preferably performed through a heat treatment when the organic solvent is removed to form toner base particles after dispersing the oil phase in the aqueous phase.

A temperature of the heat treatment is not particularly limited and may be appropriately selected in accordance with the intended purpose. The temperature is preferably 60° C. or lower, and more preferably 48° C. or higher and 54° C. or lower for avoiding fusion between the toner base particles.

After forming the toner base particles, an external additive and optionally a charge-controlling agent are added to the toner base particles. The resulting mixture is mixed by means of a blending mixer etc. to produce a toner.

The blending mixer is not particularly limited and may be appropriately selected in accordance with the intended purpose. Examples of the blending mixer include commercially available devices, such as ANGMILL (available from HOSOKAWA MICRON CORPORATION) and HENSCHEL MILL (available from NIPPON COLE & ENGINEERING CO., LTD.).

### (Developer)

The developer includes at least the toner of the present disclosure, and may further include a carrier according to the necessity. Since the toner of the present disclosure has excellent transfer properties and charging characteristics, high-quality images are stably formed using the above-mentioned developer.

The developer may be a one-component developer or a two-component developer. In the case where the developer is used for high-speed printers corresponding to information processing speed that has been improved in recent years, the developer is preferably a two-component developer considering improvement in service life of the developer.

When the developer for use in the present disclosure is a one-component developer, particle diameters of the toner particles do not noticeably vary even after replenishing the developer (i.e., the toner). Therefore, filming of the toner to a developing roller is minimized, or fusion of the toner to a member used for leveling the toner into a thin layer, such as a blade, is minimized. As a result, excellent and stable developing performance and formation of excellent images are assured even after stirring the developer in a developing device over a long period.

When the developer used in the present disclosure is a two-component developer, particle diameters of the toner particles do not noticeably vary even after replenishing the developer with the toner over a long period. As result, excellent and stable developing performance and formation of excellent images are assured even after stirring the developer in a developing device over a long period.

### <Carrier>

The carrier is not particularly limited, and may be appropriately selected in accordance with the intended purpose. The carrier includes carrier particles. Each of the carrier particles preferably includes a core particle and a resin layer covering the core particle.

### —Core Particles—

A material of the core particles is not particularly limited, and may be appropriately selected in accordance with the intended purpose. Examples of the material of the core particles include: hard-magnetic materials, such as a manganese-strontium-based material of 50 emu/g or greater and 90 emu/g or less, a manganese-magnesium-based material of 50 emu/g or greater and 90 emu/g or less, iron powder of 100 emu/g or greater, and magnetite of 75 emu/g or greater and 120 emu/g or less; and soft-magnetic materials, such as a copper-zinc-based material of 30 emu/g or greater and 80 emu/g or less. Among the above-listed examples, a hard-magnetic material (e.g., iron powder of 100 emu/g or greater, and magnetite of 75 emu/g or greater and 120 emu/g or less) is preferable for assuring image density of a resultant image. Moreover, a soft-magnetic material (e.g., a copper-zinc material of 30 emu/g or greater and 80 emu/g or less) is preferable because an impact of the developer held in the form of a brush (i.e., a magnetic brush) against the photoconductor can be reduced, and a high image quality can be assured.

The above-listed examples may be used alone or in combination.

The volume average particle diameter of the cores is not particularly limited, and may be appropriately selected in accordance with the intended purpose. The volume average particle diameter of the cores is preferably 10 μm or greater and 150 μm or less, and more preferably 40 μm or greater and 100 μm or less.

When the volume average particle diameter of the core particles is 10 μm or greater, a proportion of fine particles to the entire amount of the core particles decreases, and the decreased proportion of the fine particles leads to improvement in magnification per particle, consequently minimizing carrier scattering. When the volume average particle diameter of the core particles is 150 μm or less, a resulting carrier has a large specific surface area, and the carrier having a large specific surface area reduces toner scattering, consequently assuring excellent reproducibility of a solid image, especially a full-color image having a large solid image area.

When the toner is used for a two-component developer, the toner is mixed with the carrier.

An amount of the carrier in the two-component developer is not particularly limited, and may be appropriately selected in accordance with the intended purpose. The amount of the carrier is preferably 90 parts by mass or greater and 98 parts by mass or less, and more preferably 93 parts by mass or greater and 97 parts by mass or less, relative to 100 parts by mass of the two-component developer.

The developer is suitably used for image formation according to various electrophotographic methods known in the art, such as a magnetic one-component developing method, a non-magnetic one-component developing method, and a two-component developing method.

The toner storage unit of the present disclosure includes the toner of the present disclosure, and a unit configured to store the toner, where the toner is stored in the unit. When the toner storage unit of the present disclosure is mounted in an image forming apparatus and image formation is performed by means of the image forming apparatus, the image formation can be performed with taking advantages of the characteristics of the toner, such as no filming, excellent low-temperature fixability, hot offset resistance, high glossiness, high color-reproducibility, and heat resistant storage stability.

Examples of the toner storage unit include a toner storage container, a developing device, and a process cartridge.

The toner storage container includes a container and the toner, where the toner is stored in the container.

The developing device includes the toner, and a unit configured to store the toner and developing an image with the toner, where the toner is stored in the unit.

The process cartridge includes at least an image bearer and a developing unit as an integrated body, stores the toner therein, and is detachably mounted in an image forming apparatus.

The process cartridge may further include at least one selected from the group consisting of a charging unit, an exposing unit, and a cleaning unit.

### (Developer Storage Container)

The developer storage container includes a container and the developer, where the developer is stored in the container. The container is not particularly limited, and may be appropriately selected in accordance with the intended purpose. Examples of the container include a combination of a container main body and a cap.

A size, shape, structure, material, etc. of the container main body are not particularly limited, and may be appropriately selected in accordance with the intended purpose.

The shape of the container main body is not particularly limited, and may be appropriately selected in accordance with the intended purpose. The shape of the container main body is preferably a cylinder. When a groove is spirally formed along the inner circumferential surface of the cylindrical container main body, as the cylindrical container main body is rotated, the developer, which is the content of the container, moves towards the outlet of the container. The shape of the container main body is preferably a shape where part of or the whole of the inner circumference surface of the cylindrical container main body is pleated like a bellows.

The material of the container main body is not particularly limited, and may be appropriately selected in accordance with the intended purpose. Examples of the material of the container main body include resin materials, such as a polyester resin, a polyethylene resin, a polypropylene resin, a polystyrene resin, a polyvinyl chloride resin, polyacrylic acid, a polycarbonate resin, an ABS resin, and a polyacetal resin.

Since the developer storage unit facilitates easy storage and transportation of the developer, and allows effortless handling, the developer storage unit is detachably mounted in the process cartridge or an image forming apparatus to replenish the developer.

### (Image Forming Apparatus and Image Forming Method)

The image forming apparatus of the present disclosure includes at least an electrostatic latent image bearer, an electrostatic latent image forming unit, and a developing unit. The image forming apparatus may further include other units in accordance with the necessity.

An image forming method discussed in connection with the present disclosure includes charging, exposing, and developing. The image forming method may further include other steps, such as primary transferring, secondary transferring, fixing, and cleaning, in accordance with the necessity.

The image forming method is suitably performed by the image forming apparatus. The charging and the exposing are suitably performed by the electrostatic latent image forming unit. The developing is suitably performed by the developing unit. The above-mentioned other processes are suitably performed by the above-mentioned other units.

### <Electrostatic Latent Image Bearer>

A material, structure, and size of the electrostatic latent image bearer are not particularly limited, and may be appropriately selected in accordance with the intended purpose.

The material of the electrostatic latent image bearer is not particularly limited, and may be appropriately selected in accordance with the intended purpose. Examples of the material include inorganic photoconductors (e.g., amorphous silicon and selenium), and organic photoconductors (e.g., polysilane and phthalopolymethine). Among the above-listed examples, amorphous silicon is preferable considering long service life of the electrostatic latent image bearer.

For example, the electrostatic latent image bearer formed of amorphous silicon is produced by heating a support to a temperature that is 50° C. or higher and 400° C. or lower, and forming a photoconductive layer of amorphous silicon (a-Si) on the support according to a film formation method.

Examples of the film formation method include vacuum vapor deposition, sputtering, ion plating, thermal chemical vapor deposition (CVD), photo CVD, and plasma CVD. Among the above-listed examples, plasma CVD is preferable.

The plasma CVD is a method where a raw material gas is decomposed by direct-current, high frequency, or microwave glow discharge to deposit an a-Si film on a support.

The shape of the electrostatic latent image bearer is not particularly limited, and may be appropriately selected in accordance with the intended purpose. The shape is preferably a cylinder.

An outer diameter of the cylindrical electrostatic latent image bearer is not particularly limited, and may be appropriately selected in accordance with the intended purpose. The outer diameter is preferably 3 mm or greater and 100 mm or less, more preferably 5 mm or greater and 50 mm or less, and particularly preferably 10 mm or greater and 30 mm or less.

### <Electrostatic Latent Image Forming Unit and Forming Electrostatic Latent Image>

The electrostatic latent image forming unit is not particularly limited, provided that the electrostatic latent image forming unit is a unit configured to form an electrostatic latent image on the electrostatic latent image bearer. The electrostatic latent image forming unit may be appropriately selected in accordance with the intended purpose. Examples of the electrostatic latent image forming unit include a unit including at least a charging member configured to charge a surface of the electrostatic latent image bearer, and an exposing member configured to expose the charged surface of the electrostatic latent image bearer to light to correspond to an image to be formed.

The formation of an electrostatic latent image (i.e., the forming an electrostatic latent image) is not particularly limited, provided that the forming includes forming an electrostatic latent image on the electrostatic latent image bearer. The formation of an electrostatic latent image may be appropriately selected in accordance with the intended purpose. For example, the formation of an electrostatic latent image can be performed by charging a surface of the electrostatic latent image bearer, followed by exposing the charged surface of the electrostatic latent image bearer to light to correspond to an image to be formed. The formation of an electrostatic latent image can be performed by the electrostatic latent image forming unit.

### —Charging Member and Charging—

The charging member is not particularly limited, and may be appropriately selected in accordance with the intended purpose. Examples of the charging member include: contact chargers known in the art, each equipped with a conductor or semiconductor roller, brush, film, or rubber blade; and non-contact chargers utilizing corona discharge, such as corotron, and scorotron.

For example, the charging can be performed by applying voltage to the surface of the electrostatic latent image bearer using the charging member.

A shape or form of the charging member is not particularly limited, and may be appropriately selected in accordance with a specification or embodiment of the image forming apparatus. Examples of the form of the charging member include a roller, a magnetic brush, and a fur brush.

The charging member is preferably a contact charging member because an image forming apparatus using the contact charging member can reduce an amount of ozone generated from the charging member.

### —Exposing Member and Exposing—

The exposing member is not particularly limited, provided that the exposing member is a member capable of exposing the surface of the electrostatic latent image bearer, which has been charged by the charging member, to light to correspond to an image to be formed. The exposing member may be appropriately selected in accordance with the intended purpose. Examples of the exposing member include various exposing members, such as copy optical exposing members, rod lens array exposing members, laser optical exposing members, and liquid crystal shutter optical exposing members.

A light source used for the exposing member is not particularly limited, and may be appropriately selected in accordance with the intended purpose. Examples of the light source include general light emitters, such as a fluorescent lamp, a tungsten lamp, a halogen lamp, a mercury lamp, a sodium vapor lamp, a light emitting diode (LED), a semiconductor laser (LD), and an electroluminescent light (EL).

For applying only light having a desired wavelength range, various filters, such as a sharp-cut filter, a band-pass filter, a near infrared ray-cut filter, a dichroic filter, an interference filter, and a color temperature conversion filter, may be used with the light source.

For example, the exposure may be performed by exposing the surface of the electrostatic latent image bearer to light using the exposing member, making the exposed region correspond to an image to be formed. In the present disclosure, a back-exposure system may be employed. The back-exposure system is a system where the back side of the electrostatic latent image bearer is exposed to light to correspond to an image to be formed.

### <Developing Unit and Developing>

The developing unit is not particularly limited, provided that the developing unit is a developing unit storing the toner therein, and configured to develop the electrostatic latent image formed on the electrostatic latent image bearer with the toner to form a visible image. The developing unit may be appropriately selected in accordance with the intended purpose.

The developing is not particularly limited, provided that the developing includes developing the electrostatic latent image formed on the electrostatic latent image bearer with a toner to form a visible image. The developing may be appropriately selected in accordance with the intended purpose. For example, the developing may be performed by the developing unit.

The developing unit may be of a dry developing system or of a wet developing system. Moreover, the developing unit may be a single-color developing unit or a multiple-color developing unit.

The developing unit is preferably a developing device including a stirrer configured to stir the toner to charge the toner particles with friction, and a developer bearing member in which a magnetic field generating unit is disposed and fixed, where the developer bearing member is rotatably disposed and is configured to bear a developer including the toner on a surface of the developer bearing member.

Inside the developing unit, for example, the toner and the carrier are mixed together and stirred to charge the toner with friction caused by the stirring, and the charged developer is held on a surface of the rotating magnetic roller in the form of a brush to form a magnetic brush.

The magnetic roller is disposed closely to the electrostatic latent image bearer. Part of the toner constituting the magnetic brush formed on the surface of the magnetic roller is transferred to the surface of the electrostatic latent image bearer by electric suction force. As a result, the electrostatic latent image is developed with the toner to form a visible image formed of the toner on the electrostatic latent image bearer.

### <Other Units and Other Processes>

Examples of other units include a transferring unit, a fixing unit, a cleaning unit, a charge-eliminating unit, a recycling unit, and a controlling unit.

Examples of other processes include transferring, fixing, cleaning, charge eliminating, recycling, and controlling.

### —Transferring Unit and Transferring—

The transferring unit is not particularly limited, provided that the transferring unit is a unit configured to transfer the visible image to a recording medium. The transferring unit may be appropriately selected in accordance with the intended purpose. A preferable embodiment of the transferring unit includes a primary transferring unit and a secondary transferring unit, where the primary transferring unit is configured to transfer visible images onto an intermediate transfer member to form a composite transfer image, and the secondary transferring unit is configured to transfer the composite transfer image to a recording medium.

The transferring is not particularly limited, provided that the transferring includes transferring the visible image to a recording medium. The transferring may be appropriately selected in accordance with the intended purpose. A preferable embodiment of the transferring is transferring using an intermediate transfer member, where the transferring includes primary transferring visible images onto the intermediate transfer member, followed by secondary transferring the visible images onto the recording medium.

For example, the transferring can be performed by charging the electrostatic latent image bearer (may be referred to as a “photoconductor” hereinafter) with a transfer charger to charge the visible image. The transferring can be performed by the transferring unit.

When the images secondary transferred to the recording medium are color images of two or more-color toners, the toners of all the colors used are superimposed to form a composite image on the intermediate transfer member by the transferring unit, and the composite image on the intermediate transfer member is collectively secondary transferred to the recording medium by the intermediate transferring member.

The intermediate transfer member is not particularly limited, and may be appropriately selected from transfer members known in the art in accordance with the intended purpose. Examples of the intermediate transfer member include a transfer belt.

The transferring unit (e.g., the primary transferring unit, and the secondary transferring unit) preferably includes at least a transfer member configured to charge the visible image formed on the photoconductor to release and transfer the visible image towards the side of the recording medium.

Examples of the transfer member include a corona transfer member using corona discharge, a transfer belt, a transfer roller, a pressure transfer roller, and an adhesion transfer member.

The recording medium is typically plain paper. However, the recording medium is not particularly limited, provided that a developed image, which has not yet been fixed, can be transferred to the recording medium. The recording medium may be appropriately selected in accordance with the intended purpose. A PET base for an overhead projector (OHP) may be used as the recording medium.

### —Fixing Unit and Fixing—

The fixing unit is not particularly limited, provided that the fixing unit is a unit configured to fix the transferred image onto the recording medium. The fixing unit may be appropriately selected in accordance with the intended purpose. Examples of the fixing unit include heat-press members known in the art.

Examples of the heat-press member include a combination of a heating roller and a press roller, and a combination of a heating roller, a press roller, and an endless belt.

The fixing is not particularly limited, provided that the fixing includes fixing the transferred visible image onto the recording medium. The fixing may be appropriately selected in accordance with the intended purpose. For example, the fixing may be performed every time when an image of each color toner is transferred to the recording medium. Alternatively, the fixing may be performed once in the state where images of all of the color toners are superimposed.

The fixing may be performed by the fixing unit.

A heating temperature of the heat-press member is not particularly limited, and may be appropriately selected in accordance with the intended purpose. The heating temperature is preferably 80° C. or higher and 200° C. or lower.

In the present disclosure, an optical fixing device known in the art may be used in combination with or instead of the fixing unit in accordance with the intended purpose.

The surface pressure applied during the fixing is not particularly limited, and may be appropriately selected in accordance with the intended purpose. The surface pressure is preferably 10 N/cm² or greater and 80 N/cm² or less.

### —Cleaning Unit and Cleaning—

The cleaning unit is not particularly limited, provided that the cleaning unit is a unit configured to remove the toner remaining on the photoconductor. The cleaning unit may be appropriately selected in accordance with the intended purpose. Examples of the cleaning unit include a magnetic brush cleaner, an electrostatic brush cleaner, a magnetic roller cleaner, a blade cleaner, a brush cleaner, and a web cleaner.

The cleaning is not particularly limited, provided that the cleaning can remove the residual toner on the photoconductor. The cleaning may be appropriately selected in accordance with the intended purpose. For example, the cleaning may be performed by the cleaning unit.

### —Charge-Eliminating Unit and Charge Eliminating—

The charge-eliminating unit is not particularly limited, provided that the charge-eliminating unit is a unit configured to apply charge-eliminating bias to the photoconductor to eliminate the charge of the photoconductor. The charge-eliminating unit may be appropriately selected in accordance with the intended purpose. Examples of the charge-eliminating unit include a charge-eliminating lamp.

The charge eliminating is not particularly limited, provided that the charge eliminating includes applying charge-eliminating bias to the photoconductor to eliminate the residual charge of the photoconductor. The charge eliminating may be appropriately selected in accordance with the intended purpose. For example, the charge eliminating may be performed by the charge-eliminating unit.

### —Recycling Unit and Recycling—

The recycling unit is not particularly limited, provided that the recycling unit is a unit configured to recycle the toner removed by the cleaning to be used in the developing device. The recycling unit may be appropriately selected in accordance with the intended purpose. Examples of the recycling unit include conveying units known in the art.

The recycling is not particularly limited, provided that the recycling includes recycling the toner removed by the cleaning to be used in the developing device. The recycling may be appropriately selected in accordance with the intended purpose. For example, the recycling may be performed by the recycling unit.

### —Controlling Unit and Controlling—

The controlling unit is not particularly limited, provided that the controlling unit is a unit configured to control operation of each unit. The controlling unit may be appropriately selected in accordance with the intended purpose. Examples of the controlling unit include devices, such as a sequencer, and a computer.

The controlling is not particularly limited, provided that the controlling includes controlling an operation of each unit in each step. The controlling may be appropriately selected in accordance with the intended purpose. For example, the controlling may be performed by the controlling unit.

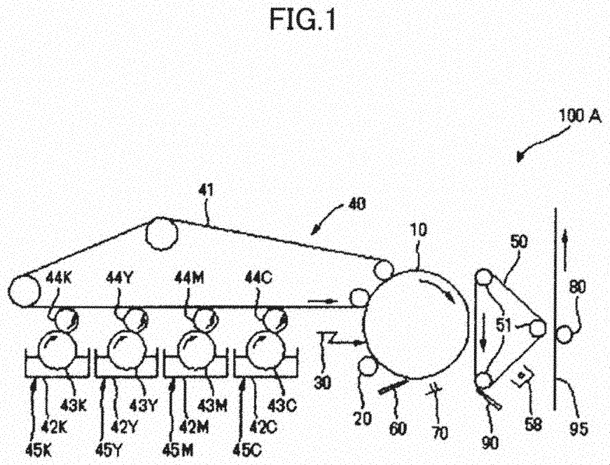

Next, one embodiment for carrying out a method of forming an image using the image forming apparatus of the present disclosure will be described with reference to FIG. 1.

A color image forming apparatus 100A of FIG. 1 includes a photoconductor drum 10 (may be referred to as a “photoconductor 10” hereinafter) serving as the electrostatic latent image bearer, a charging roller 20 serving as the charging unit, an exposure device 30 serving as the exposing unit, a developing device 40 serving as the developing unit, an intermediate transfer member 50, a cleaning device 60 serving as the cleaning unit having a cleaning blade, and a charge-eliminating lamp 70 serving as the charge-eliminating unit.

The intermediate transfer member 50 is an endless belt, and is rotatably driven by three rollers 51 in the direction indicated with an arrow in FIG. 1. The three rollers 51 are disposed inside the loop of the endless belt to support the endless belt.

Part of the three rollers 51 may also function as a transfer bias roller capable of applying predetermined transfer bias (or primary transfer bias) to the intermediate transfer member 50.

The cleaning device 90 including the cleaning blade is disposed closely to the intermediate transfer member 50.

Moreover, the transfer roller 80 is disposed closely to the intermediate transfer member 50 in a manner that the transfer roller 80 faces the intermediate transfer member 50. The transfer roller serves as the transferring unit capable of applying transfer bias for transferring (or secondary transferring) the developed image (also referred to as the visible image or the toner image) to transfer paper 95 serving as the recording medium.

The corona charger 58 configured to apply charge to the toner image on the intermediate transfer member 50 is disposed in a position at the periphery of the intermediate transfer member 50, where the position is located between a contact area between the photoconductor 10 and the intermediate transfer member 50, and the contact area between the intermediate transfer member 50 and the transfer paper 95 relative to the rotational direction of the intermediate transfer member 50.

The developing device 40 includes a developer belt 41 serving as the developer bearing member, and a black developing unit 45K, a yellow developing unit 45Y, a magenta developing unit 45M, and a cyan developing unit 45C. The black developing unit 45K, yellow developing unit 45Y, magenta developing unit 45M, and cyan developing unit 45C are disposed in series at the periphery of the developing belt 41.

The black developing unit 45K includes a developer storage unit 42K, a developer supply roller 43K, and a developing roller 44K.

The yellow developing unit 45Y includes a developer storage unit 42Y, a developer supply roller 43Y, and a developing roller 44Y.

The magenta developing unit 45M includes a developer storage unit 42M, a developer supply roller 43M, and a developing roller 44M.

The cyan developing unit 45C includes a developer storage unit 42C, a developer supply roller 43C, and a developing roller 44C.

Moreover, the developing belt 41 is an endless belt rotatably supported by two or more belt rollers. Part of the developing belt 41 comes into contact with the electrostatic latent image bearer 10.

In the color image forming apparatus 100A of FIG. 1, for example, the charging roller 20 uniformly charges a surface of the photoconductor drum 10.

The exposure device 30 exposes the charged surface of the photoconductor drum 10 to light to correspond to an image to be formed, forming an electrostatic latent image.

The toner is supplied from the developing device 40 to develop the electrostatic latent image formed on the photoconductor drum 10, forming a toner image.

Voltage is applied from the roller 51 to the toner image to transfer (or primary transfer) the toner image onto the intermediate transfer member 50, followed by transferring (or secondary transferring) onto transfer paper 95.

As a result, the transferred image is formed on the transfer paper 95.

The residual toner on the photoconductor 10 is removed by the cleaning device 60. The residual charge of the photoconductor 10 is temporarily removed by the charge-eliminating lamp 70.

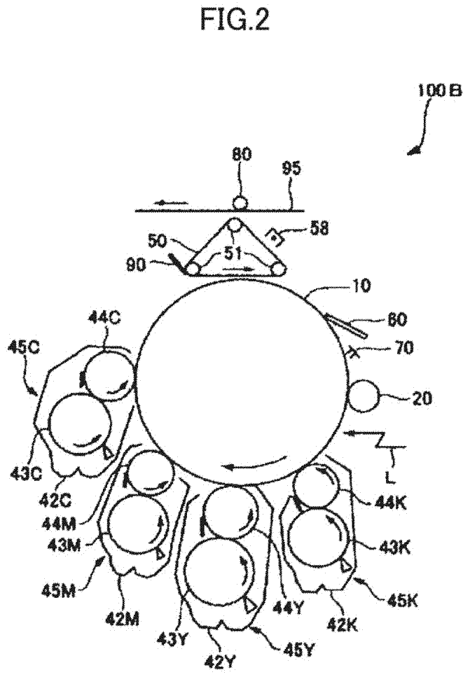

FIG. 2 illustrates another example of the image forming apparatus of the present disclosure.

The image forming apparatus 100B has the structure identical to the structure of the image forming apparatus 100A of FIG. 1, provided that the developing belt 41 is not disposed, and the black developing unit 45K, the yellow developing unit 45Y, the magenta developing unit 45M, and the cyan developing unit 45C are disposed at the periphery of the photoconductor drum 10 to directly face the photoconductor drum 10.

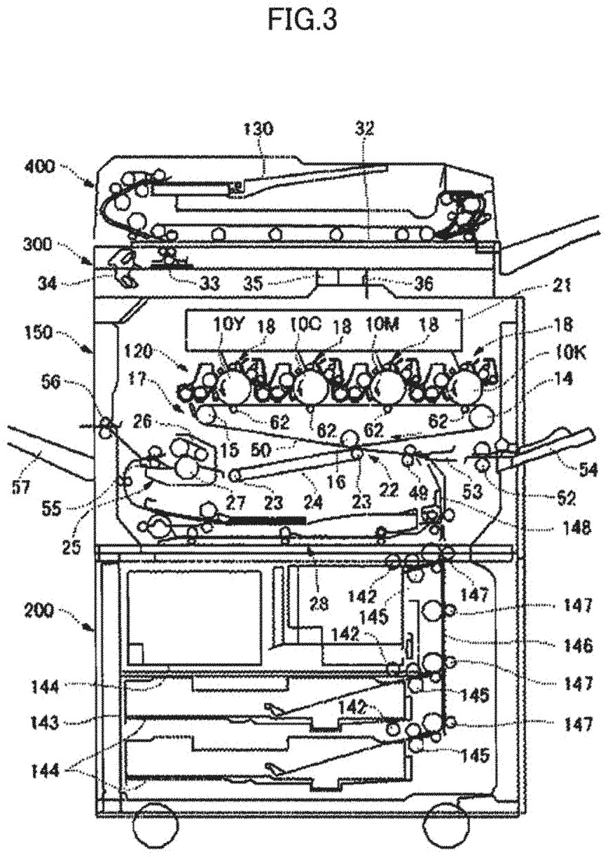

FIG. 3 illustrates yet another example of the image forming apparatus of the present disclosure.

The image forming apparatus illustrated in FIG. 3 includes a photocopier main body 150, a paper feeding table 200, a scanner 300, and an automatic document feeder (ADF) 400.

An intermediate transfer member 50, which is an endless belt, is disposed at the central part of the photocopier main body 150.

The intermediate transfer member 50 is supported by support rollers 14, 15, and 16, and is rotatably disposed in the clockwise direction in FIG. 3.

An intermediate transfer member cleaning device 17 is disposed closely to the support roller 15. The intermediate transfer member cleaning device 17 is configured to remove the residual toner on the intermediate transfer member 50.

A tandem developing device 120 is disposed to face the section of the intermediate transfer member 50 supported by the support rollers 14 and 15. In the tandem developing device 120, four image forming units 18, i.e., a yellow image forming unit, a cyan image forming unit, a magenta image forming unit, and a black image forming unit, are arranged in series along the travelling direction of the intermediate transfer member 50.

An exposure device 21 serving as the exposing member is disposed closely to the tandem developing device 120.

A secondary transfer device 22 is disposed to the side of the intermediate transfer member 50 opposite to the side where the tandem developing device 120 is disposed.

The secondary transfer device 22 includes a secondary transfer belt 24. The secondary transfer belt 24 is an endless belt and is supported by a pair of rollers 23. Transfer paper borne on and transported by the secondary transfer belt 24 comes into contact with the intermediate transfer member 50.

A fixing device 25 serving as the fixing member is disposed closely to the secondary transfer device 22.

The fixing device 25 includes a fixing belt 26, which is an endless belt, and a press roller 27 disposed to press against the fixing belt 26.

The tandem image forming apparatus includes a sheet reverser 28 disposed closely to the secondary transfer device 22 and to the fixing device 25. The sheet reverser 28 is configured to reverse transfer paper to perform image formation on both sides of the transfer paper.

Next, formation of a full-color image (i.e., a color copy) using the tandem developing device 120 will be described.

First, a document is set on a document table 130 of the automatic document feeder (ADF) 400. Alternatively, a document is set on contact glass 32 of a scanner 300 by opening the automatic document feeder 400. Once the document is set, the automatic document feeder 400 is closed.

Once a start switch (not illustrated) is pressed, if the document is set on the automatic document feeder 400, the document is transported onto the contact glass 32, and then the scanner 300 is driven. If the document is initially set on the contact glass 32, the scanner 300 is immediately driven once the start switch is pressed.

Then, a first carriage 33 and a second carriage 34 are driven to scan the document.

During the scanning, the first carriage 33 irradiates a surface of the document with light emitted from a light source, and the light reflected from the surface of the document is again reflected by a mirror of the second carriage 34 to slip through an imaging forming lens 35. The light is then received by a reading sensor 36 to read the color document (e.g., the color image) to acquire image information of black, yellow, magenta, and cyan.

The image information of each of black, yellow, magenta, and cyan is transmitted to the corresponding image forming unit 18 (the black image forming unit, the yellow image forming unit, the magenta image forming unit, or the cyan image forming unit) of the tandem developing device 120.

By means of each image forming unit, a toner image of each color (black, yellow, magenta, or cyan) is formed.

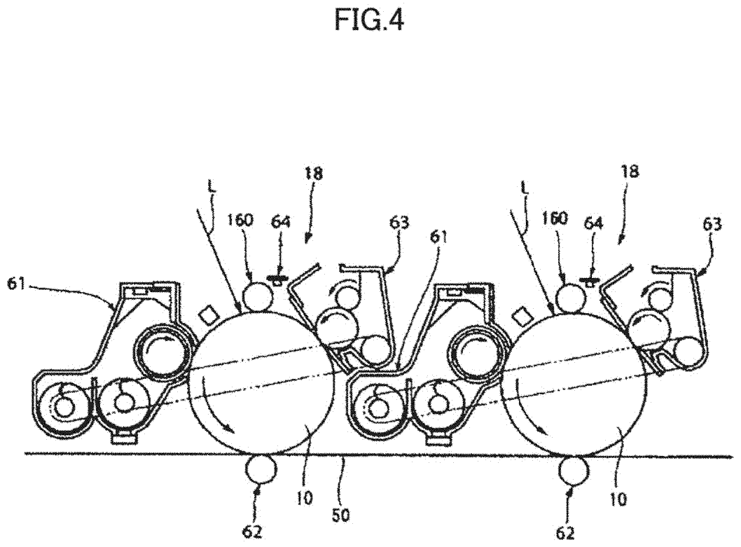

Specifically, as illustrated in FIG. 4, each image forming unit 18 (the black image forming unit, the yellow image forming unit, the magenta image forming unit, or the cyan image forming unit) of the tandem developing device 120 includes: an electrostatic latent image bearer 10 (a black electrostatic latent image bearer 10K, a yellow electrostatic latent image bearer 10Y, a magenta electrostatic latent image bearer 10M, or a cyan electrostatic latent image bearer 10C); a charging device 160 that is the charging device configured to uniformly charge a surface of the electrostatic latent image bearer 10; an exposure device configured to expose the electrostatic latent image bearer to light (L in FIG. 4) to correspond to each color image based on the corresponding color image information, to thereby form an electrostatic latent image corresponding to each color image on the electrostatic latent image bearer; a developing device 61 configured to develop the electrostatic latent image with the corresponding color toner (the black toner, the yellow toner, the magenta toner, or the cyan toner), to thereby form a toner image of the corresponding color toner; a transfer charger 62 configured to transfer the toner image to an intermediate transfer member 50; a cleaning device 63; and a charge-eliminating unit 64.

Each image forming unit 18 can form an image of a single color (e.g., a black image, a yellow image, a magenta image, and a cyan image) based on the corresponding color image information.

The black image formed on the black electrostatic latent image bearer 10K, the yellow image formed on the yellow electrostatic latent image bearer 10Y, the magenta image formed on the magenta electrostatic latent image bearer 10M, and the cyan image formed on the cyan electrostatic latent image bearer 10C in the above-described manner are sequentially transferred (or primary transferred) onto the intermediate transfer member 50 that is rotatably supported by the support rollers 14, 15, and 16.

The black image, the yellow image, the magenta image, and the cyan image are superimposed on the intermediate transfer member 50 to form a composite color image (i.e., a transferred color image).

In the paper feeding table 200, meanwhile, one of paper feeding rollers 142 is selectively driven to rotate to feed sheets (i.e., recording paper) from one of paper feeding cassettes 144 stacked in a paper bank 143.

The sheets are separated one by one by a separation roller 145 to feed each sheet into a paper feeding path 146, and the fed sheet is transported by a transport roller 147 to guide the sheet into a paper feeding path 148 inside the photocopier main body 150. The sheet is then caused to collide with a registration roller 49 to stop.

Alternatively, a paper feeding roller 142 is driven to rotate to feed sheets (i.e., recording paper) on a manual feed tray 54, and the sheets are separated and fed into a manual paper feeding path 53 one by one with a separation roller 52. Similarly, the fed sheet is caused to collide with a registration roller 49 to stop.

The registration roller 49 is typically grounded during use, but the registration roller 49 may be used in the state where bias is applied to the registration roller 49 for removing paper dusts from sheets.

Synchronizing with the timing of the composite color image (i.e., the transferred color image) formed on the intermediate transfer member 50, the registration roller 49 is driven to rotate to feed the sheet (i.e., the recording paper) between the intermediate transfer member 50 and the secondary transfer device 22. The composite color image (i.e., the transferred color image) is then transferred (or secondary transferred) onto the sheet (i.e., the recording paper) by the secondary transfer device 22.

In the manner as described above, the color image is transferred and formed onto the sheet (i.e., the recording paper).

After transferring the image, the residual toner on the intermediate transfer member 50 is cleaned by the intermediate transfer member cleaning device 17.

The sheet (i.e., the recording paper) on which the color image has been transferred is transported by the secondary transfer device 22 to send the sheet to the fixing device 25. By means of the fixing device 25, heat and pressure are applied to the composite color image (i.e., the transferred color image) to fix the composite color image to the sheet (i.e., the recording paper).

Thereafter, the traveling direction of the sheet (i.e., the recording paper) is switched by the switching claw 55 to eject the sheet (i.e., the recording paper) with an ejection roller 56 to stack the sheet (i.e., the recording paper) on the paper ejection tray 57.

Alternatively, the traveling direction of the sheet (i.e., the recording paper) is switched by the switching claw 55 and the sheet is flipped by the sheet reverser 28 to return to the transfer position. After recording an image also on the back side of the sheet, the sheet is ejected by the ejection roller 56 to stack on the paper ejection tray 57.

### (Toner Storage Unit)

The toner storage unit of the present disclosure is configured in a manner that the toner storage unit is detachably mounted in various image forming apparatuses. The toner storage unit includes an electrostatic latent image bearer configured to bear an electrostatic latent image, and a developing unit configured to develop the electrostatic latent image on the electrostatic latent image bearer with the toner of the present disclosure to form a visible image (i.e., a toner image).

The toner storage unit of the present disclosure may further include other members according to the necessity.

The developing unit includes at least a developer storage unit, in which the developer of the present disclosure is stored, and a developer bearing member configured to bear the developer stored in the developer storage unit.

The developing unit may further include a regulating member configured to regulate a thickness of a layer of the developer borne on the developer bearing member.

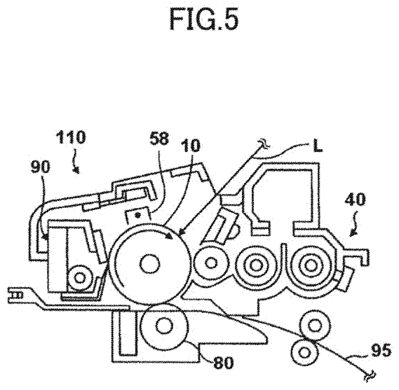

FIG. 5 illustrates an example of the process cartridge discussed in connection with the present disclosure. The process cartridge 110 includes a photoconductor drum 10, a corona discharger 58, a developing device 40, a transfer roller 80, and a cleaning device 90.

The numerical reference 95 is transfer paper, and L is exposure light.

### EXAMPLES

The present disclosure will be described below by way of Examples. The present disclosure should not be construed as being limited to these Examples. In Examples, “part(s)” denotes “part(s) by mass” and “%” denotes “% by mass” unless otherwise stated.

### (Synthesis of Ketimine Compound)

A reaction vessel equipped with a stirring rod and a thermometer was charged with 170 parts by mass of isophoronediamine and 75 parts by mass of methyl ethyl ketone. The resulting mixture was allowed to react for 5 hours at 50° C. to yield a ketimine compound. The ketimine compound had an amine value of 418 mgKOH/g.

### (Synthesis of Amorphous Polyester A)

A reaction vessel equipped with a cooling tube, a stirrer, and a nitrogen-inlet tube was charged with 3-methyl-1,5-pentanediol, adipic acid, and trimellitic anhydride in a manner that a molar ratio of a carboxyl group to a hydroxyl group was to be 1.5 and an amount of the trimellitic anhydride in the total amount of the monomers was to be 1 mol %. To the resulting mixture, 1,000 ppm of titanium tetraisopropoxide was added.

Next, the resulting mixture was heated to 200° C. for about 4 hours, followed by further heating to 230° C. for 2 hours to proceed with the reaction until no more water was generated from the reaction. Thereafter, the resulting product was allowed to react for 5 hours under the reduced pressure of from 10 mmHg through 15 mmHg, to thereby yield a hydroxyl group-containing amorphous polyester.

A reaction vessel equipped with a cooling tube, a stirrer, and a nitrogen-inlet tube was charged with the hydroxyl group-containing amorphous polyester and isophorone diisocyanate in a manner that a molar ratio of a hydroxyl group to an isocyanate group was to be 2.0. After diluting the resulting mixture with ethyl acetate, the diluted solution was allowed to react for 5 hours at 100° C., to thereby yield a 50% amorphous polyester prepolymer A ethyl acetate solution.

A reaction vessel equipped with a heater, a stirrer, and a nitrogen inlet tube was charged with a 50% amorphous polyester prepolymer A ethyl acetate solution, followed by stirring. To the solution, the ketimine compound was added by dripping in a manner that a molar ratio of an amino group to an isocyanate group was to be 1.

After stirring the resulting mixture for 10 hours at 45° C., the mixture was dried at 50° C. under the reduced pressure until the amount of the residual ethyl acetate was to be 100 ppm or less, to thereby yield amorphous polyester A.

The amorphous polyester A had a glass transition temperature of −55° C., and a weight average molecular weight of 130,000.

### (Synthesis of Amorphous Polyester B)

A reaction vessel equipped with a nitrogen-inlet tube, a dehydration tube, a stirrer, and a thermocouple was charged with a bisphenol A ethylene oxide (2 mol) adduct (may be abbreviated as “Bis A-EO”), a bisphenol A propylene oxide (3 mol) adduct (may be abbreviated as “Bis A-PO”), terephthalic acid, and adipic acid in a manner that a molar ratio of Bis A-EO to Bis A-PO was to be 40/60, a molar ratio of terephthalic acid to adipic acid was to be 93/7, and a molar ratio of a hydroxyl group to a carboxyl group was to be 1.2. To the resulting mixture, 500 ppm of titanium tetraisopropoxide was added relative to the total amount of the monomers.

The resulting mixture was allowed to react for 8 hours at 230° C., followed by further reacting for 4 hours under the reduced pressure of from 10 mmHg through 15 mmHg.

After adding 1 mol % trimellitic anhydride relative to a total amount of the monomer, the resultant mixture was allowed to react for 3 hours at 180° C., to thereby yield amorphous polyester B.

The amorphous polyester B had a glass transition temperature of 67° C., and a weight average molecular weight of 10,000.

### (Synthesis of Crystalline Polyester C)

A reaction vessel equipped with a nitrogen-inlet tube, a dehydration tube, a stirrer, and a thermocouple was charged with sebacic acid and 1,6-hexanediol in a manner that a molar ratio of a carboxyl group to a hydroxyl group was to be 0.9. To the resulting mixture, 500 ppm of titanium tetraisopropoxide was added relative to a total amount of the monomers.

Next, the resulting mixture was allowed to react for 10 hours at 180° C., followed by heating to 200° C. and reacting the mixture for 3 hours.

The resulting reaction solution was further allowed to react for 2 hours under the reduced pressure of 8.3 kPa, to thereby yield crystalline polyester C.

The crystalline polyester C had a melting point of 67° C., and a weight average molecular weight of 25,000.

### <Production of Master Batch>

By means of HENSCHEL MIXER (available from NIPPON COKE & ENGINEERING CO., LTD.), 1,200 parts by mass of water, 500 parts by mass of carbon black (Printex35, available from Degussa, DBP oil absorption: 42 mL/100 mg, pH: 9.5), and 500 parts by mass of the amorphous polyester B were mixed together. Then, the resulting mixture was kneaded for 30 minutes at 150° C. by a two-roll kneader.

Next, the resulting kneaded product was rolled and cooled, followed by pulverizing by means of a pulverizer, to thereby produce a master batch.

### <Synthesis of Wax Dispersing Agent>

An autoclave equipped with a thermometer and a stirrer was charged with 480 parts by mass of xylene, and 100 parts by mass of polyethylene (SANWAX 151P, available from SANYO CHEMICAL CO., LTD.) having a melting point of 108° C. and a weight average molecular weight of 1,000, followed by dissolving the polyethylene with nitrogen purging.

Next, a mixed solution including 805 parts by mass of styrene, 50 parts by mass of acrylonitrile, 45 parts by mass of butyl acrylate, 36 parts by mass of di-t-butyl peroxide, and 100 parts by mass of xylene was added to the reaction solution by dripping over the course of 3 hours. The resulting mixture was allowed to react at 170° C. and the temperature was maintained at 170° C. for 30 minutes.

The solvent was removed from the resulting reaction solution, to thereby yield a wax dispersing agent.

The wax dispersing agent had a glass transition temperature of 65° C., and a weight average molecular weight of 18,000.

### <Preparation of Wax Dispersion Liquid>

A vessel equipped with a stirring rod and a thermometer was charged with 300 parts by mass of paraffin wax HNP-9 (available from Nippon Seiro Co., Ltd.) having a melting point of 75° C. serving as a release agent, 150 parts by mass of the wax dispersing agent, and 1,800 parts by mass of ethyl acetate.

Next, the resulting mixture was heated to 80° C. with stirring, and the temperature was maintained at 80° C. for 5 hours, followed by cooling down to 30° C. over the course of 1 hour.

Moreover, the resulting dispersion liquid was further dispersed by passing 3 times through ULTRA VISCOMILL (available from AIMEX CO., LTD.), which was a bead mill filled with zirconia beads having diameters of 0.5 mm by 80% by volume, to thereby yield a wax dispersion liquid.

During the dispersing performed by ULTRA VISCOMILL, the feeding rate was set at 1 kg/h, and the circumferential speed of the disk was set at 6 m/s.

### <Preparation of Crystalline Polyester Dispersion Liquid>

A vessel equipped with a stirring rod and a thermometer was charged with 308 parts by mass of the crystalline polyester C, and 1,900 parts by mass of ethyl acetate.

Next, the resulting mixture was heated to 80° C. with stirring, and the temperature was maintained at 80° C. for 5 hours, followed by cooling down to 30° C. over the course of 1 hour.

Moreover, the resulting dispersion liquid was further dispersed by passing 3 times through ULTRA VISCOMILL (available from AIMEX CO., LTD.), which was a bead mill filled with zirconia beads having diameters of 0.5 mm by 80% by volume, to thereby prepare a crystalline polyester dispersion liquid.

During the dispersing performed by ULTRA VISCOMILL, the feeding rate was set at 1 kg/h, and the circumferential speed of the disk was set at 6 m/s.

### Example 1

### <Preparation of Oil Phase>

A vessel was charged with 500 parts by mass of the wax dispersion liquid, 705 parts by mass of the crystalline polyester dispersion liquid, 228 parts by mass of the prepolymer, 836 parts by mass of the amorphous polyester A, 100 parts by mass of the master batch, 6 parts by mass of the inorganic filler (i.e., trimethylstearylammonium-modified montmorillonite), and 2 parts by mass of the ketimine compound serving as a curing agent. The resulting mixture was mixed by means of a TK Homomixer (available from PRIMIX Corporation) for 60 minutes at 5,000 rpm, to thereby prepare an oil phase.

### <Synthesis of Vinyl-Based Resin Dispersion Liquid>

A reaction vessel equipped with a stirring rod and a thermometer was charged with 683 parts by mass of water, 11 parts by mass of a sodium salt of sulfuric acid ester of a methacrylic acid-ethylene oxide adduct (ELEMINOL RS-30, available from SANYO CHEMICAL CO., LTD.), 138 parts by mass of styrene, 138 parts by mass of methacrylic acid, and 1 part by mass of ammonium persulfate. The resulting mixture was stirred for 15 minutes at 400 rpm, to thereby prepare a white emulsion.

Next, the internal temperature of the reaction system was increased to 75° C. to react the emulsion for 5 hours. To the resulting product, 30 parts by mass of a 1% ammonium persulfate aqueous solution was added, and the resulting mixture was matured for 5 hours at 75° C., to thereby yield a vinyl-based resin dispersion liquid.

The resin particles in the vinyl-based resin dispersion liquid had the volume average particle diameter of 0.14 μm. The volume average particle diameter was measured by means of a laser diffraction/scattering particle size analyzer LA-920 (available from HORIBA).

### <Preparation of Aqueous Phase>

Pure water (810 parts by mass), 83 parts by mass of the vinyl-based resin dispersion liquid, 37 parts by mass of a 48.5% by mass sodium dodecyldiphenyl ether disulfonate aqueous solution (ELEMINOL MON-7, available from SANYO CHEMICAL CO., LTD.), 180 parts by mass of sodium sulfate, and 90 parts by mass of ethyl acetate were mixed and stirred, to thereby prepare a milky white aqueous phase.

### <Emulsification and Removal of Solvent>

To the vessel charged with the oil phase, 0.2 parts by mass of the ketimine compound and 1,200 parts by mass of the aqueous phase were added. The resulting mixture was mixed by means of a TK Homomixer for 20 minutes at 13,000 rpm, to thereby prepare an emulsified slurry.

Next, a vessel equipped with a stirrer and a thermometer was charged with the emulsified slurry, followed by removing the solvent for 8 hours at 30° C. Then, the resulting product was matured for 4 hours at 45° C., to thereby prepare a dispersion slurry. During the production process of toner base particles, amorphous polyester A was generated.

### <Washing>

The dispersion slurry (100 parts by mass) was subjected to vacuum filtration.

Next, 100 parts by mass of ion-exchanged water was added to the filtration cake. The resulting mixture was mixed by means of a TK Homomixer for 10 minutes at 12,000 rpm, followed by performing filtration (may be referred to as Washing Process (1), hereinafter).

To the resulting cake, 100 parts by mass of a 10% sodium hydroxide aqueous solution was added. The resulting mixture was mixed by means of the TK Homomixer for 30 minutes at 12,000 rpm, followed by performing vacuum filtration (may be referred to as Washing Process (2), hereinafter).

Next, 100 parts by mass of 10% hydrochloric acid was added to the filtration cake. The resulting mixture was mixed by means of the TK Homomixer for 10 minutes at 12,000 rpm, followed by performing filtration (may be referred to as Washing Process (3), hereinafter).

Moreover, 300 parts by mass of ion-exchanged water was added to the filtration cake. The resulting mixture was mixed by means of the TK Homomixer for 10 minutes at 12,000 rpm, followed by performing filtration (may be referred to as Washing Process (4), hereinafter).

A set of Washing Processes (1) to (4) were performed twice.

### <Surface Treatment>

To the resulting filtration cake obtained by the washing, 100 parts by mass of ion-exchanged water was added. The resulting mixture was mixed by means of a TK Homomixer for 10 minutes at 12,000 rpm, to thereby produce a toner dispersion liquid. After heating the toner dispersion liquid at 53° C. for 15 minutes to perform a surface treatment, a heat treatment was performed for 4 hours at 45° C., followed by performing filtration.

### <Drying>

After completing the surface treatment, the resulting filtration cake was dried by means of an air circulation dryer for 48 hours at 45°. The resulting dried product was sieved through a sieve having a mesh-size of 75 μm, to thereby acquire toner base particles.

### <Addition of External Additive>

By means of HENSCHEL MIXER (available from NIPPON COKE & ENGINEERING CO., LTD.), 100 parts by mass of the toner base particles, 2.0 parts by mass of hydrophobic silica having the number average primary particles of 150 nm, 0.5 parts by mass of hydrophobic titanium oxide particles having the number average primary particle diameter of 20 nm, and 1.0 part by mass of hydrophobic silica particles having the number average primary particle diameter of 15 nm were mixed, to thereby produce Toner 1.

### <Measuring Method of Volume Average Particle Diameter>

The volume average particle diameter of the toner was measured by means of Coulter Multisizer II (available from Beckman Coulter Inc.). First, from 0.1 mL through 5 mL of a surfactant (e.g., a nonionic surfactant, preferably polyoxyethylene alkyl ether) serving as a dispersing agent was added to from 100 mL through 150 mL of an electrolytic aqueous solution.

The electrolytic aqueous solution was a 1% by mass NaCl aqueous solution that was prepared using Grade-1 sodium chloride. For example, ISOTON-II (available from Beckman Coulter, Inc.) may be used as the electrolytic aqueous solution.

Next, from 2 mg through 20 mg of the measurement sample was added to the electrolytic aqueous solution.

The resulting electrolytic aqueous solution in which the sample was suspended was subjected to a dispersion treatment for about 1 minute through about 3 minutes by means of an ultrasonic disperser. The toner particle diameter and the number of the toner particles were measured by means of the measuring device with an aperture of 100 μm, to thereby determine the volume average particle diameter Dv.

### <Measuring Method of Average Circularity>

The average circularity of the toner was measured by means of a wet flow particle image analyzer FPIA-2100 and analysis software FPIA-2100 Data Processing Program for FPIA version 00-10 (available from SYSMEX CORPORATION).

Specifically, the average circularity of the toner was measured in the following manner. A 100 mL glass beaker was charged with 0.1 mL through 0.5 mL of a 10% alkylbenzene sulfonic acid salt (NEOGEN SC-A, available from DKS Co., Ltd.) aqueous solution and from 0.1 g through 0.5 g of the toner. The resulting mixture was stirred by means of a microspartel, followed by adding 80 mL of ion-exchanged water.

Next, the resulting mixture was dispersed by means of an ultrasonic disperser UH-50 (available from SMT CO., LTD.) for 1 minute at 20 kHz, and at 50 W/10 cm³, followed by dispersing. After dispersing for 5 minutes in total, a measurement sample was obtained.

The measurement sample having a particle concentration of from 4,000 particles/10⁻³ cm³ through 8,000 particles/10⁻³ cm³ was used to measure the average circularity of the particles having a circle equivalent diameter of 0.60 μm or greater and less than 159.21 μm. Based on the measured average circularity, the average circularity of the toner was calculated.

### <Measuring Method of Arithmetic Mean Height Sa of Surfaces of Toner Particles>

A scanning probe microscopy (SPM) used in the present disclosure is a method where a sample surface is scanned with a probe with a tip having a diameter of about 10 nm to detect the atomic force acting between the probe and atoms of a surface of a sample to measure a surface profile of the sample. The SPM forms an image with extremely high resolution and can measure a surface profile along the z-axial direction relative to the scanning direction (i.e., x-axial direction) of the probe. In the present disclosure, a surface of the toner particle was scanned with a probe of SPM to measure a surface profile of the toner particle.

When the surface of the toner particle was measured by the SPM method, an area, which is about 1 μm², located near a peak of a certain toner base particle is scanned with a tip of a probe. During the scanning, the vertical deviation was read as information for z-axis. The above-described measurement was performed from 3 times through 10 times with changing a measuring point or a toner base particle of the sample to be measured, to capture a shape of a whole particle and shapes of all particles. As a practical method, first, the surface profile was evaluated from an SPM image to confirm a state of the additive deposited on the surface of the toner base particle, and then a quantitative surface profile analysis was performed. Moreover, the arithmetic mean height Sa defined in the present disclosure was calculated from the profile obtained by the SPM measurement.

The conditions of the SPM measuring device were as follows.

Measuring device: Atomic force microscope system, Dimension Icon, available from Bruker AXS

### Measuring Mode

Peak Force QNM

OMCL-AC240TS

Material: Si

Resonance frequency: 70 [Hz]

Cantilever spring constant: 2 [N/m]

### <Measuring Method of BET Specific Surface Area>

The BET specific surface area of the toner particles was measured by means of an automatic surface area and porosity analyzer (TriStar3000, available from Shimadzu Corporation).

The toner was weighed by about 0.5 g and collected in a sample cell. The collected sample was vacuum-dried for 24 hours by means of Pretreatment Smart-Prep (available from Shimadzu Corporation) to remove impurities and moisture on the surface of the sample. After the pretreatment, the sample was set in the automatic surface area and porosity analyzer (TriStar3000, available from Shimadzu Corporation) to determine relation between the nitrogen gas adsorption and relative pressure.

The BET specific surface area of the toner was determined from the relation between the nitrogen gas adsorption and the relative pressure according to the multipoint BET method.

### <Measuring Method of Number Average Primary Particle Diameter of External Additive>

A SEM image of a toner particle was captured by a scanning electron microscope (SEM) (SU8230, available from Hitachi High-Tech Corporation) under the following measuring conditions, and the number average primary particle diameter d of the external additive particles was measured by image analysis. A major axis (a length of the longest part) of a primary particle was measured on 100 particles of the external additive, and an average value of the measured values was calculated. The calculated average value was provided as a number average primary particle diameter d.

### [SEM Measuring Conditions]

Acceleration voltage: 3.0 kV
Working distance (WD): 10.0 mm
Observation magnification: 50,000×

### Example 2

Toner 2 was obtained in the same manner as in Example 1, except that, in the preparation of the oil phase, 6 parts by mass of the inorganic filler was replaced with 7 parts by mass of the inorganic filler; and in the emulsification and removal of the solvent, the mixing for 20 minutes at 13,000 rpm was changed to mixing for 20 minutes at 10,000 rpm.

### Example 3

Toner 3 was obtained in the same manner as in Example 1, except that, in the preparation of the oil phase, 6 parts by mass of the inorganic filler was replaced with 7 parts by mass of the inorganic filler.

### Example 4

Toner 4 was obtained in the same manner as in Example 1, except that, in the preparation of the oil phase, 6 parts by mass of the inorganic filler was replaced with 8 parts by mass of the inorganic filler; and in the emulsification and removal of the solvent, the mixing for 20 minutes at 13,000 rpm was changed to mixing for 20 minutes at 10,000 rpm.

### Example 5

Toner 5 was obtained in the same manner as in Example 1, except that, in the preparation of the oil phase, 6 parts by mass of the inorganic filler was replaced with 8 parts by mass of the inorganic filler; and in the surface treatment, the heating for 15 minutes at 53° C. was changed to heating for 15 minutes at 50° C.

### Example 6

Toner 6 was obtained in the same manner as in Example 1, except that, in the preparation of the oil phase, 6 parts by mass of the inorganic filler was replaced with 10 parts by mass of the inorganic filler; in the emulsification and removal of the solvent, the mixing for 20 minutes at 13,000 rpm was changed to mixing for 20 minutes at 10,000 rpm; and in the surface treatment, the heating for 15 minutes at 53° C. was changed to heating for 15 minutes at 47° C.

### Example 7

Toner 7 was obtained in the same manner as in Example 1, except that 6 parts by mass of the inorganic filler was replaced with 10 parts by mass of the inorganic filler; and in the surface treatment, the heating for 15 minutes at 53° C. was changed to 15 minutes at 47° C.

### Example 8

Toner 8 was obtained in the same manner as in Example 1, except that, in the preparation of the oil phase, 705 parts by mass of the crystalline polyester dispersion liquid was replaced with 880 parts by mass of the crystalline polyester dispersion liquid, and 6 parts by mass of the inorganic filler was replaced with 11 parts by mass of the inorganic filler; and in the emulsification and removal of the solvent, the mixing for 20 minutes at 13,000 rpm was changed to mixing for 20 minutes at 10,000 rpm.

### Example 9

Toner 9 was obtained in the same manner as in Example 1, except that, in the preparation of the oil phase, 705 parts by mass of the crystalline polyester dispersion liquid was replaced with 880 parts by mass of the crystalline polyester dispersion liquid, and 6 parts by mass of the inorganic filler was replaced with 11 parts by mass of the inorganic filler; and in the surface treatment, the heating for 15 minutes at 53° C. was replaced with heating for 15 minutes at 45° C.

### Example 10

Toner 10 was obtained in the same manner as in Example 4, except that, in the addition of the external additive, the hydrophobic silica having the number average primary particle diameter of 150 nm was replaced with hydrophobic silica having the number average primary particle diameter of 80 nm.

### Example 11

Toner 11 was obtained in the same manner as in Example 4, except that, in the addition of the external additive, the hydrophobic silica having the number average primary particle diameter of 150 nm was replaced with hydrophobic silica having the number average primary particle diameter of 50 nm.

### Comparative Example 1

Toner 12 was obtained in the same manner as in Example 1, except that, in the preparation of the oil phase, 6 parts by mass of the inorganic filler was replaced with 5 parts by mass of the inorganic filler; and in the surface treatment, the heating for 15 minutes at 53° C. was changed to heating for 15 minutes at 55° C.

### Comparative Example 2

Toner 13 was obtained in the same manner as in Example 1, except that, in the emulsification and removal of the solvent, the mixing for 20 minutes at 13,000 rpm was changed to mixing for 20 minutes at 7,000 rpm.

### Comparative Example 3

Toner 14 was obtained in the same manner as in Example 1, except that, in the preparation of the oil phase, 6 parts by mass of the inorganic filler was replaced with 12 parts by mass of the inorganic filler; and in the emulsification and removal of the solvent, the mixing for 20 minutes at 13,000 rpm was changed to mixing for 20 minutes at 10,000 rpm.

### Comparative Example 4

Toner 15 was obtained in the same manner as in Example 1, except that, in the preparation of the oil phase, 6 parts by mass of the inorganic filler was replaced with 12 parts by mass of the inorganic filler; in the emulsification and removal of the solvent, the mixing for 20 minutes at 13,000 rpm was changed to mixing for 20 minutes at 10,000 rpm; and in the surface treatment, the heating for 15 minutes at 53° C. was changed to heating for 15 minutes at 45° C.

### Comparative Example 5

Toner 16 was obtained in the same manner as in Example 1, except that, in the preparation of the oil phase, 6 parts by mass of the inorganic filler was replaced with 15 parts by mass of the inorganic filler; in the emulsification and removal of the solvent, the mixing for 20 minutes at 13,000 rpm was changed to mixing for 20 minutes at 10,000 rpm; and in the surface treatment, the heating for 15 minutes at 53° C. was changed to heating for 15 minutes at 45° C.

### Comparative Example 6

Toner 17 was obtained in the same manner as in Example 1, except that, in the preparation of the oil phase, 6 parts by mass of the inorganic filler was replaced with 10 parts by mass of the inorganic filler; and in the emulsification and removal of the solvent, the mixing for 20 minutes at 13,000 rpm was changed to mixing for 20 minutes at 6,000 rpm.

### Comparative Example 7

Toner 18 was obtained in the same manner as in Example 1, except that, in the preparation of the oil phase, 6 parts by mass of the inorganic filler was replaced with 10 parts by mass of the inorganic filler; and in the surface treatment, the heating for 15 minutes at 53° C. was changed to heating for 15 minutes at 47° C.

### Comparative Example 8

Toner 19 was obtained in the same manner as in Example 1, except that, in the surface treatment, the heating for 15 minutes at 53° C. was changed to heating for 15 minutes at 56° C.

The toners obtained in Examples 1 to 11 and Comparative Examples 1 to 8 were evaluated for “cleaning properties” and “transfer properties.” The results are presented in Table 1-2. Moreover, the measurement results of the “average circularity,” “arithmetic mean height Sa,” “BET specific surface area,” “number average primary particle diameter d of the external additive,” and “arithmetic mean height Sa/number average primary particle diameter d of the external additive” of the obtained toners are presented in Table 1-1.

### <Cleaning Properties>

By means of a modified device of a color multifunction peripheral RICOH IMC6000 available from Ricoh Company Limited, each of the toners of Examples and Comparative Examples was used to print a chart having an imaging area of 5% (A4 size in landscape orientation) on 100,000 sheets in an atmosphere of 23° C. and 53% RH. Thereafter, 50,000 sheets of a blank chart (A4 size in landscape orientation) were output both in an environment of 10° C. and 15% RH, and in an environment of 32° C. and 54% RH, followed by printing a longitudinal band chart (A4 size in landscape orientation) on 100 sheets. The obtained images were observed with naked eye, to evaluate the presence of an image defect due to a cleaning failure.

### [Evaluation Criteria]

Excellent: The toner being passed through a cleaning blade due to a cleaning failure was not observed with naked eye on the printed sheet nor on the photoconductor, and a linear toner residue was not confirmed as the photoconductor was observed under a microscope along a longitudinal direction.
Good: The toner being passed through a cleaning blade due to a cleaning failure was not observed on a printed sheet nor on a photoconductor by observation with naked eye.
Fair: The toner being passed through a cleaning blade due to a cleaning failure was slightly observed on a photoconductor with naked eye, but the toner was not confirmed on a printed sheet.
Poor: The toner being passed through a cleaning blade due to a cleaning failure was observed with naked eye on the printed sheet and on the photoconductor.

### <Transfer Properties>

By means of a modified device of a color multifunction peripheral RICOH IMC6000 available from Ricoh Company Limited, each of the toners of Examples and Comparative Examples was used to print a chart having an imaging area of 5% (A4 size in landscape orientation) on 100,000 sheets in an atmosphere of 23° C. and 53% RH. On the initial test image, and after outputting 100,000 sheets, a transfer rate from the primary transferring was determined according to Formula (3) and a transfer rate from the secondary transferring was determined according to Formula (4).

The evaluation criteria were presented below.

Primary transfer rate (%)=(an amount of the toner transferred onto the intermediate transfer member/an amount of the toner deposited on the electrophotographic photoconductor to develop)×100 [Formula (3)]

Secondary transfer rate (%)=(an amount of the toner transferred onto the intermediate transfer member−an amount of the residual toner on the intermediate transfer after transferring/an amount of the toner transferred onto the intermediate transfer member)×100 [Formula (4)]

The transfer properties were evaluated by calculating an average value of the primary transfer rate and the secondary transfer rate, and evaluating the average value based on the following evaluation criteria.

### [Evaluation Criteria]

Excellent: 90% or greater
Good: 85% or greater and less than 90%
Fair: 80% or greater and less than 85%
Poor: less than 80%<

### <Image Defect>

By means of a modified device of a color multifunction peripheral RICOH IMC6000 available from Ricoh Company Limited, each of the toners of Examples and Comparative Examples was used to print a chart having an imaging area of 5% (A4 size in landscape orientation) on 100,000 sheets in an atmosphere of 10° C. and 15% RH, in an atmosphere of 23° C. and 53% RH, and in an atmosphere of 32° C. and 54% RH. Then, occurrences of image defects were evaluated. As an image defect, an image causing a fixing failure was judged as being defective, and other images were judged as being normal.

### [Evaluation Criteria]

Good: There was no image defect.
Poor: There was an image defect.

### <Comprehensive Evaluation>

A comprehensive evaluation of each of the toners of Examples and Comparative Examples was performed based on the evaluation results of the “cleaning properties,” “transfer properties,” and “image defect” in accordance with the following evaluation criteria.

### [Evaluation Criteria]

Good: All of the evaluation results of the “cleaning properties,” “transfer properties,” and “image defect” were “Good” or better.
Poor: At least any one of the evaluation results of the “cleaning properties,” “transfer properties,” and “image defect” was “Fair” or worse.

TABLE 1-1

| | | External | | | | |
|---|---|---|---|---|---|---|
| | | additive | | | | |
| | | Number | | | | |
| | | average | Toner base particles | | | |
| | | primary | | BET | | |
| | | particle | | specific | Arithmetic | |
| | Toner | diameter | Average | surface | mean height | |
| | No. | d (nm) | circularity | area | Sa | d/Sa |
| Ex. 1 | 1 | 152 | 0.985 | 1.3 | 45 | 3.38 |
| Ex. 2 | 2 | 149 | 0.982 | 1.4 | 61 | 2.44 |
| Ex. 3 | 3 | 149 | 0.981 | 1.3 | 53 | 2.81 |
| Ex. 4 | 4 | 149 | 0.07 | 1.5 | 58 | 2.57 |
| Ex. 5 | 5 | 148 | 0.978 | 1.5 | 72 | 2.05 |
| Ex. 6 | 6 | 151 | 0.976 | 2.1 | 76 | 1.99 |
| Ex. 7 | 7 | 151 | 0.976 | 2.1 | 89 | 1.7 |
| Ex. 8 | 8 | 152 | 0.974 | 1.6 | 87 | 1.76 |
| Ex. 9 | 9 | 152 | 0.974 | 2.5 | 103 | 1.48 |
| Ex. 10 | 10 | 82 | 0.979 | 1.5 | 58 | 1.41 |
| Ex. 11 | 11 | 53 | 0.979 | 1.5 | 58 | 0.91 |
| Comp. | 12 | 152 | 0.986 | 1.2 | 46 | 3.3 |
| Ex. 1 | | | | | | |
| Comp. | 13 | 152 | 0.984 | 1.3 | 35 | 4.34 |
| Ex. 2 | | | | | | |
| Comp. | 14 | 152 | 0.973 | 1.6 | 93 | 1.63 |
| Ex. 3 | | | | | | |
| Comp. | 15 | 151 | 0.974 | 2.7 | 102 | 1.48 |
| Ex. 4 | | | | | | |
| Comp. | 16 | 152 | 0.968 | 2.5 | 121 | 1.26 |
| Ex. 5 | | | | | | |
| Comp. | 17 | 152 | 0.979 | 1.5 | 41 | 3.71 |
| Ex. 6 | | | | | | |

TABLE 1-2

| | | Evaluation results | | | |
|---|---|---|---|---|---|
| | Toner | Cleaning | Transfer | Image | Comprehensive |
| | No. | properties | properties | defect | evaluation |
| Ex. 1 | 1 | Good | Excellent | Good | Good |
| Ex. 2 | 2 | Excellent | Excellent | Good | Good |
| Ex. 3 | 3 | Excellent | Excellent | Good | Good |
| Ex. 4 | 4 | Excellent | Excellent | Good | Good |
| Ex. 5 | 5 | Excellent | Good | Good | Good |
| Ex. 6 | 6 | Excellent | Good | Good | Good |
| Ex. 7 | 7 | Excellent | Good | Good | Good |
| Ex. 8 | 8 | Excellent | Good | Good | Good |
| Ex. 9 | 9 | Excellent | Good | Good | Good |
| Ex. 10 | 10 | Excellent | Excellent | Good | Good |
| Ex. 11 | 11 | Good | Excellent | Good | Good |
| Comp. | 12 | Poor | Excellent | Poor | Poor |
| Ex. 1 | | | | | |
| Comp. | 13 | Poor | Excellent | Good | Poor |
| Ex. 2 | | | | | |
| Comp. | 14 | Excellent | Fair | Good | Poor |
| Ex. 3 | | | | | |
| Comp. | 15 | Fair | Fair | Good | Poor |
| Ex. 4 | | | | | |
| Comp. | 16 | Excellent | Poor | Good | Poor |
| Ex. 5 | | | | | |
| Comp. | 17 | Fair | Excellent | Poor | Poor |
| Ex. 6 | | | | | |

It was confirmed from Table 1-2 that the toners of Examples 1 to 11, which were the toners of the present disclosure, had excellent results of the “cleaning properties,” “transfer properties,” “image defect,” and “comprehensive evaluation.”

For example, embodiments of the present disclosure are as follows.

<1> A toner including:

toner particles, each of the toner particles including a toner base particle, the toner base particle including a binder resin and a release agent,

wherein the toner particles have an average circularity of 0.974 or greater and 0.985 or less,

an arithmetic mean height Sa of surfaces of the toner particles is 45 nm or greater, and

the toner particles have a BET specific surface area of 1.3 m²/g or greater and 2.5 m²/g or less.

<2> The toner according to <1>,

wherein each of the toner particles further includes particles of an external additive,
wherein the particles of the external additive are deposited on a surface of the toner base particle, and
wherein a ratio (d/Sa) of a number average primary particle diameter d of the particles of the external additive to the arithmetic mean height Sa is 1 or greater and 3 or less.

<3> The toner according to <2>,

wherein the number average primary particle diameter d of the particles of the external additive is 80 nm or greater.

<4> The toner according to <2> or <3>, wherein the external additive is silica.

<5> The toner according to any one of <1> to <4>,

wherein the binder resin includes a crystalline polyester, and
an amount of the crystalline polyester relative to the binder resin is 6% by mass or greater and 12% by mass or less.

<6> The toner according to any one of <1> to <5>,

wherein the toner base particle further includes an inorganic filler.

<7> A toner production method, including: dissolving or dispersing a binder resin in an organic solvent to prepare an oil phase; and

dispersing the oil phase in an aqueous phase to form toner base particles,
wherein the toner production method is a method of producing the toner according to any one of <1> to <6>.

<8> A toner storage unit including: the toner according to any one of <1> to <6>; and a unit in which the toner stored.

<9> An image forming apparatus, including: the toner storage unit according to <8> detachably mounted in the image forming apparatus,

wherein the toner storage unit further includes:
an electrostatic latent image bearer configured to bear an electrostatic latent image; and
a developing unit configured to develop the electrostatic latent image on the electrostatic latent image bearer with the toner to form a visible image.

The toner according to any one of <1> to <6>, the toner production method according to <7>, the toner storage unit according to <8>, and the image forming apparatus according to <9> can solve the above-described various problems existing in the art, and can achieve the object of the present disclosure.

What is claimed is:

1. A toner comprising:
toner particles, each of the toner particles including a toner base particle, the toner base particle including a binder resin and a release agent,
wherein the toner particles have an average circularity of 0.974 or greater and 0.985 or less,
an arithmetic mean height Sa of surfaces of the toner particles is 45 nm or greater, and
the toner particles have a BET specific surface area of 1.3 m²/g or greater and 2.5 m²/g or less.

2. The toner according to claim 1,
wherein each of the toner particles further includes particles of an external additive,
wherein particles of the external additive are deposited on a surface of the toner base particle, and
wherein a ratio (d/Sa) of a number average primary particle diameter d of the particles of the external additive to the arithmetic mean height Sa is 1 or greater and 3 or less.

3. The toner according to claim 2,
wherein the number average primary particle diameter d of the particles of the external additive is 80 nm or greater.

4. The toner according to claim 2,
wherein the external additive is silica.

5. The toner according to claim 1,
wherein the binder resin includes a crystalline polyester, and
an amount of the crystalline polyester relative to the binder resin is 6% by mass or greater and 12% by mass or less.

6. The toner according to claim 1,
wherein the toner base particle further includes an inorganic filler.

7. A toner production method, comprising:
dissolving or dispersing a binder resin in an organic solvent to prepare an oil phase; and
dispersing the oil phase in an aqueous phase to form toner base particles,
wherein the toner production method is a method of producing the toner according to claim 1.

8. A toner storage unit comprising:
the toner according to claim 1; and
a unit in which the toner stored.

9. An image forming apparatus, comprising:
the toner storage unit according to claim 8 detachably mounted in the image forming apparatus,
wherein the toner storage unit further includes:
an electrostatic latent image bearer configured to bear an electrostatic latent image; and
a developing unit configured to develop the electrostatic latent image on the electrostatic latent image bearer with the toner to form a visible image.
